(19) United States
(12) Patent Application Publication
(10) Pub. No.: US 2025/0249632 A1
(43) Pub. Date: Aug. 7, 2025

(54) METHOD FOR PRODUCING A PLASTIC COMPOUND HAVING IMPROVED PROPERTIES

(71) Applicant: Covestro Deutschland AG, Leverkusen (DE)

(72) Inventors: Reiner Rudolf, Langenfeld (DE); Youjin Wu, Jiangsu (CN); Carsten Conzen, Leverkusen (DE); Michael Bierdel, Leverkusen (DE); Thomas Koenig, Leverkusen (DE)

(21) Appl. No.: 18/857,087

(22) PCT Filed: Apr. 11, 2023
(86) PCT No.: PCT/EP2023/059380

§ 371 Date: Oct. 15, 2024

(30) Foreign Application Priority Data
Apr. 19, 2022 (EP) 22168866.6

(51) Int. Cl. B29C 48/00; B29C 48/405; B29K 23/00; B29K 25/00; B29K 27/00; B29K 33/00; B29K 67/00; B29K 69/00; C08K 5/521

(52) U.S. Cl. CPC B29C 48/022; B29C 48/405; C08K 5/521; B29K 2023/04; B29K 2023/10; B29K 2025/06; B29K 2025/08; B29K 2027/16; B29K 2033/12; B29K 2067/003; B29K 2067/006; B29K 2069/00

(57) ABSTRACT

The present invention relates to a method for producing a plastic compound having improved properties from a formulation containing at least two thermoplastic components in a multi-shaft screw machine having screw shafts rotating in the same direction, in parallel and at the same speed, wherein the plastic compound (i) does not comprise an additive which is flowable at 23° C. or (ii) comprises precisely one additive which is flowable at 23° C., or (iii) comprises at least two additives which are flowable at 23° C. The present invention relates in particular to the production of a plastic compound from a formulation containing at least two thermoplastic components, at least one of which is a polycarbonate. More particularly, the screw machine is a twin-screw extruder having screw shafts rotating in the same direction, in parallel and at the same speed.

### CROSS REFERENCE TO RELATED APPLICATIONS

This application is a U.S. national stage application, filed under 35 U.S.C. § 371, of International Application No. PCT/EP2023/059380, which was filed on Apr. 11, 2023, and which claims priority to European Patent Application No. 22168866.6, which was filed on Apr. 19, 2022. The entire contents of each are hereby incorporated by reference into this specification.

### FIELD

The present invention provides a process for producing a plastic mass having improved properties from a formulation comprising at least two thermoplastic components in a multishaft screw machine having corotating parallel screw shafts that rotate at equal speed, wherein the plastic mass
(i) does not include any additive that is free-flowing at 23° C.,
or
(ii) includes exactly one additive that is free-flowing at 23° C.,
or
(iii) includes at least two additives that are free-flowing at 23° C.

In particular, the present invention provides here for the production of a plastic mass from a formulation comprising at least two thermoplastic components, at least one of which is a polycarbonate. It is further the case, in particular, that the screw machine is a twin-screw extruder having corotating parallel screw shafts that rotate at equal speed.

### BACKGROUND

Multishaft screw machines having corotating parallel screw shafts that rotate at equal speed are sufficiently well known from the technical literature, for example from [1] ([1]=Klemens Kohlgrüber: Der gleichläufige Doppelschneckenextruder [The Corotating Twin-Shaft Extruder], 2nd edition, Hanser Verlag Munich 2016.

The uses of such screw machines—also called extruders-include for compounding of plastic or viscoelastic masses, especially compounding of plastics, especially in turn for compounding of melts or solutions of thermoplastic polymers or melts or solutions of rubbers: [1], pages 50 to 63.

If two or more different thermoplastic components having distinctly different viscosity are present in a formulation for production of a plastic mass, it is difficult to achieve good plastification with simultaneously high throughput of plastic mass through the screw machine and low energy input into the plastic mass.

The fact that it is difficult to achieve good plastification is described, for example, in the paper “Melting Model for Co-Rotating Twin-Screw Extruders”, Elemans, P. H. M. et al., ANTEC 2002, Conference Proceedings, Volume I, Processing, pages 355 to 359. A solution proposed here is to distinctly reduce the pellet size of the thermoplastic component used in order to obtain good plastification. However, only formulations with just one thermoplastic component, Arnitel® 40D, are used and considered here.

It is not possible to infer any instructions from the results presented in order to produce a plastic mass with good plastification from polycarbonate-containing formulations with at least two thermoplastic components. Furthermore, a reduction in the pellet size of the thermoplastic components used is difficult to achieve since the thermoplastic components in the formulation are generally not produced in-house but acquired commercially from external manufacturers.

In the papers “Melting of polymer blends in co-rotating twin screw extruders. Part I, Part II, Part III”, Potente, H. et al., Int. Polymer Processing XVI (2001) 2, pages 124-130, 131-142 and 143-150, proceeding from a literature search and experiments, a model for calculation of the quality of classification for thermoplastic components is presented, which is implemented in the SIGMA simulation software. The experiments for verification of the model are conducted with a mixture of the thermoplastic components PA6 and PP. However, FIGS. 12-14 on pages 149 and 150 show that agreement between experiments and calculation is very low. It is also stated on the basis of the experiments that the pellet sizes of the thermoplastic components used and the ratio of pellet sizes of the thermoplastic components used and the flight depth of the screw elements are significant process-specific variables in order to achieve good plastification. The effect of pellet size is discussed only theoretically; no experiments with different pellet sizes are detailed. In addition, the viscosity ratio of the thermoplastic components is mentioned as being crucial for good plastification. However, only qualitative statements are made.

Since the model has only low agreement with the results of the experiments, it is not possible to infer any instructions therefrom in order to produce a plastic mass with good plastification from formulations having at least two thermoplastic components, at least one of which is a polycarbonate.

The paper “Evaluation of melting performance of a co-rotating twin-screw extruder”, Elemans, P. H. M. et al., ANTEC 2002, Conference Proceedings, Volume I, Processing, pages 350-354, shows by experiments with a formulation composed of a thermoplastic component that the quality of plastification increases in a linear manner with the dwell time in the extruder and additionally depends significantly on the screw speed. However, it remains unclear what throughput was used to conduct the experiments. All that is stated is a torque to be established as a percentage, although there is no information as to what torque in nM corresponds to a torque of 100%. All experiments were conducted with formulations that contain only Arnitel® 40D as the sole thermoplastic component.

Since only a formulation with one thermoplastic component was examined and the settings for the experiment are not documented, it is not possible to infer any instructions by which a plastic mass with good plastification would be producible from formulations having at least two thermoplastic components, at least one of which is a polycarbonate.

In the paper “Melting of high-heat Polyamide in a co-rotating twin-screw extruder”, Janssen, J. M. H., Sierksma, W. R., ANTEC 2002, Conference Proceedings, Volume III, Special Areas, pages 3712-3715, it is shown by experiments with a formulation composed of nylon-4,6, nylon-4,6 and nylon-6 and with addition of otherwise unspecified low-melting additives that a high energy input, a low speed, a low torque and a long and melt-filled kneading block zone improve the quality of plastification, but the addition of nylon-6 and/or low melting additives to nylon-4,6 worsen plastification. In addition, it is pointed out that, in the case of a higher speed, there is a rise in energy input but at the same time a drop in the quality of plastification because of inadequate dwell time in the extruder.

No instructions can be inferred from the results presented in order to produce a plastic mass having good plastification from polycarbonate-containing formulations with at least two thermoplastic components, since merely qualitative statements are made with regard to the influence of the process parameters, the screw set and formulation components. Moreover, no instructions by which good plastification can be achieved with simultaneously high economic viability are given. The reduction in the speed and the torque inevitably lead to a lower throughput and hence low economic viability.

Nor is there any pointer in the prior art as to how the parameters that affect the quality of plastification can be linked to one another such that good plastification can be achieved if at all possible even when one or more of these influencing parameters cannot be or should not be altered, for example for reasons of cost or quality, in that one or more of the other influencing parameters is/are altered in a suitable manner.

### SUMMARY

It is therefore an object of the present invention to provide a process for producing a plastic mass with good plastification in a multishaft screw machine with corotating parallel screw shafts that rotate at equal speed, in which the influencing parameters that affect the quality of plastification are adjusted such that good plastification is achieved. It is a further object of the present invention to provide a process for producing a plastic mass with good plastification in a multishaft screw machine with corotating parallel screw shafts that rotate at equal speed, where the influencing parameters that affect the quality of plastification can be adjusted such that good plastification is achieved even when at least one of these influencing parameters cannot or should not be altered, in that one or more of the other influencing parameters are altered in a suitable manner. The process according to the invention is thus to achieve good plastification very substantially independently of the screw machine used, the screw set thereof, the diameter thereof, the number of shafts thereof, the components of the formulation for production of the plastic mass, and the process parameters, for example speed of the screw shafts and mass flow of the plastic mass through the screw machine. In particular, the formulation from which the plastic mass is produced is to comprise at least two thermoplastic components, at least one of which is a polycarbonate.

Good plastification in the context of the present invention has the feature that there are wholly or partly unmelted particles of the thermoplastic components present in the formulation in not more than 5% of the number of pellets produced from the plastic mass, especially in not more than 3% of the number of pellets produced from the plastic mass, very particularly in not more than 2% of the number of pellets produced from the plastic mass, and further in particular in none of the pellets produced from the plastic mass. A number of more than 2%, especially a number of more than 3%, very particularly a number of more than 5%, of pellets in which there are wholly or partly unmelted particles is unacceptable.

It has been found that, surprisingly, the object is achieved by a process having the features of the main claim.

In particular, it has been found that good plastification is achieved when what is called a melting rate is kept in a particular range of values. This melting rate is a dimensionless index.

Further in particular, it has been found that good plastification is achieved when the melting rate in the longitudinal section of the screw machine that begins at a distance of twice the internal housing diameter D upstream of the first screw element that is not a conveying element and ends with the last screw element of the screw machine is from 1.18 to 8, is preferably from 1.18 to 5, is more preferably from 1.2 to 3,
where this melting rate is as follows:

$$Melting rate = \frac{( {τ}_{1} \cdot {δη}_{1} + {τ}_{2} \cdot {δη}_{2} ) \cdot λ \cdot n \cdot {D}^{3}}{{d}^{2} \cdot {c}_{p} \cdot \dot{m}}$$

and where:
τ₁ is the average dwell time of the plastic mass in the longitudinal section of the screw machine that begins at a distance of twice the internal housing diameter D upstream of the first screw element that is not a conveying element,
and
in case (i)
ends with the last screw element of the screw machine,
and in cases (ii) or (iii)
ends with the first addition site for an additive that is free-flowing at 23° C. downstream of the first screw element that is not a conveying element,
and where
δη₁ is the ratio of the dynamic viscosity of the plastic mass at a shear rate \dot{γ} corresponding to the speed n of the screw shafts and
   in case (i)
   of a temperature of the plastic mass of 230° C.
and
   in case (ii)
   of a temperature of the plastic mass of 230° C. minus 230° C. multiplied by twice the proportion by mass of the exactly one additive that is free-flowing at 23° C. based on the mass of the plastic mass,
and
   in case (iii)
   of a temperature of the plastic mass of 230° C. minus (230° C. multiplied by twice the sum total of the proportions by mass of the at least two additives that are free-flowing at 23° C. based on the total mass of the plastic mass)
based on the dynamic viscosity of the thermoplastic component having the highest dynamic viscosity measured at a shear rate \dot{γ} of 200 l/s and
   in case (i)
   at a temperature of 230° C.
and
   in case (ii)
   at a temperature of 230° C. minus 230° C. multiplied by twice the proportion by mass of the exactly one additive that is free-flowing at 23° C. based on the mass of the plastic mass,
and
   in case (iii)
   at a temperature of 230° C. minus (230° C. multiplied by twice the sum total of the proportions by mass of the at least two additives that are free-flowing at 23° C. based on the mass of the plastic mass),
τ₂ is
   in case (ii) and in case (iii)
   the average dwell time of the plastic mass in the longitudinal section of the screw machine that begins with the first addition site for an additive that is free-flowing at 23° C. downstream at a distance of twice the inner internal housing diameter D upstream of the first screw element that is not a conveying element and ends with the last screw element of the screw machine,
and
   in case (i)
   is zero,
δη₂ is the ratio of the dynamic viscosity of the plastic mass at a shear rate \dot{γ} corresponding to the speed n of the screw shafts and at a temperature corresponding to the temperature of the plastic mass at the end of the last screw element, based on the dynamic viscosity of the thermoplastic component having the highest dynamic viscosity measured at a shear rate of 200 l/s and at a temperature corresponding to the temperature of the plastic mass at the end of the last screw element,
λ is the thermal conductivity measured to EN ISO 11357-8:2021 at 23° C., exhibited by the plastic mass immediately after exiting from the screw machine,
n is the speed of the screw shafts of the screw machine,
d is the diameter of the pellets of the polycarbonate present in the formulation for production of the plastic mass that has the highest relative viscosity measured to EN ISO 1628-1:2021,
D is the internal diameter of the housings of the screw machine, where the internal housing diameter
D is the same for all housings of the screw machine here,
cₚ is the average specific heat capacity measured to ISO 11357-4:2021 in the temperature range between 250° C. and 300° C.,
\dot{m} is the mass flow rate of the plastic mass in the screw machine.

This is especially true of a:
process for producing a plastic mass
in a multishaft screw machine with corotating parallel screw shafts that rotate at equal speed,
wherein the screw shafts rotate at a speed n,
wherein the plastic mass is produced from a formulation containing at least two thermoplastic components,
wherein at least one of the at least two thermoplastic components is a polycarbonate,
wherein the plastic mass
   (i) does not include any additive that is free-flowing at 23° C.,
or
   (ii) includes exactly one additive that is free-flowing at 23° C.,
or
   (iii) includes at least two additives that are free-flowing at 23° C.,
wherein the dynamic viscosity of the plastic mass measured to ISO 11443:2014 Method A2 at a shear rate \dot{γ} of 200 l/s
and
   in case (i)
   of a temperature of 230° C.
and
   in case (ii)
   of a temperature of 230° C. minus 230° C. multiplied by twice the proportion by mass of the exactly one additive that is free-flowing at 23° C. based on the mass of the plastic mass,
and
   in case (iii)
   of a temperature of 230° C. minus 230° C. multiplied by twice the sum total of the proportions by mass of the at least two additives that are free-flowing at 23° C. based on the mass of the plastic mass,
based on the viscosity of at least one of these thermoplastic components measured to ISO 11443:2014 Method A2, measured at a shear rate Y of 200 l/s and a temperature of 230° C., is in a ratio of 0.3 to 3,
and wherein the at least two thermoplastic components differ in at least one of the following features: at least one structural unit is different,
or
the difference in relative solution viscosity, measured to EN ISO 1628-1:2021, is at least 5%,
wherein the process is characterized by a melting rate.

By way of further elucidation, it should be noted that:

The speed n is the number of rotations in a period of time based on said period of time, and corresponds to the reciprocal of the period of revolution T, i.e. n=1/T.

The difference in the relative solution viscosity, measured to EN ISO 1628-1:2021, is determined in dichloromethane at a concentration of 5 g of sample per liter of dichloromethane at 25° C. with an Ubbelohde viscometer.

δη₁ is the ratio of the dynamic viscosity of the plastic mass at a shear rate \dot{γ} corresponding to the speed n of the screw shafts. The simplifying equation is possible since shear rate is proportional to speed.

d is the diameter of the pellets of the polycarbonate present in the formulation for production of the plastic mass that has the highest relative viscosity measured to EN ISO 1628-1:2021, and was calculated as the equivalent sphere diameter from the weight of 100 pellets and the solid-state density as follows:

$$d = {( \frac{6 \cdot {m}_{100}}{{ρ}_{solids} \cdot π} )}^{\frac{1}{3}}$$

where:
m₁₀₀ is the weight of 100 pellets of the polycarbonate present in the formulation for production of the plastic mass that has the highest relative viscosity measured to EN ISO 1628-1:2021, measured with a commercial balance,
r_{solids} is the density measured to EN ISO 1183-1:2019 (Method A) of the polycarbonate present in the formulation for production of the plastic mass that has the highest relative viscosity measured to EN ISO 1628-1:2021,
p is the circle constant.

### BRIEF DESCRIPTION OF DRAWINGS

FIG. 1 is a photograph of a top side of pellets according to the present disclosure.

FIG. 2 shows an illustration of pellets having unmelted particles and pellets having vacuoles according to the present disclosure.

FIG. 3 shows a labelled version of the photograph of FIG. 1.

FIG. 4 shows a basic construction of an extruder according to the present disclosure.

FIG. 5 shows a basic construction of an extruder according to the present disclosure.

FIG. 6 shows a basic construction of an extruder according to the present disclosure.

### DETAILED DESCRIPTION

In the context of the present invention, based on the multishaft screw machine, details relating to the position and direction should always be considered in conveying direction of the overall multishaft screw machine.

Preferably according to the invention, the multishaft screw machine is a twin-screw extruder having corotating parallel screw shafts that rotate at equal speed. These screw shafts are fitted with screw elements which each preferably mesh tightly with the respectively immediately adjacent screw elements of the respectively immediately adjacent screw shafts. These screw shafts are outwardly encompassed by an outer housing having an inner contour that is likewise adapted to the screw shafts. The housing of the twin-screw extruder having screw shafts in a mutually parallel arrangement may be both designed to be heatable and coolable.

Alternatively, it is preferable according to the invention that the multishaft screw machine is a multishaft extruder having corotating parallel screw shafts in a mutually annular arrangement that rotate at equal speed. Such a multishaft extruder has 8 to 16, usually 10 or 12, corotating screw shafts. In such a screw machine too, screw shafts are fitted with screw elements which each preferably mesh tightly with the respectively immediately adjacent screw elements of the respectively immediately adjacent screw shafts. These screw shafts are in an annular arrangement around an inner core having a contour adapted to the screw shafts fitted with the screw elements. Each screw shaft is immediately adjacent to two other screw shafts. These screw shafts are outwardly encompassed by an outer housing having an inner contour that is likewise adapted to the screw shafts. The housing and/or the core of the multiscrew extruder having screw shafts in a mutually annular arrangement may be both designed to be heatable and coolable.

In the context of the present invention, such a multiscrew extruder having screw shafts in a mutually annular arrangement is also referred to hereinafter as a ring extruder.

The screw elements of a ring extruder are no different than those of a twin-screw extruder addressing the same process engineering objective. The process zones of a ring extruder are also no different than those of a twin-screw extruder addressing the same process engineering objective.

Ring extruders in and of themselves are known for example from:

DE4412725A1, DE4412741A1, DE19622582A1, DE202007004997U1, DE202007005010U1, WO03020493A1 and WO2006045412A2 and also from the publication “Compoundieren mit zwölf Wellen” [“Compounding with Twelve Shafts”] Carl Hanser Verlag, Munich, KU Kunststoffe, volume 90 (2000) 8, pages 60 to 62.

The plastic mass produced in the process according to the invention is especially a melt of a formulation containing at least two thermoplastic components, at least one of which is a polycarbonate. The second thermoplastic component may also be a polycarbonate, but it may also be a different thermoplastic polymer. The same is true of any further thermoplastic components used. Each one of these further thermoplastic components that may be used may, independently of the others, be a polycarbonate or a different thermoplastic polymer. It is thus also possible for all the thermoplastic components of the formulation according to the invention to be polycarbonates.

In the context of the present invention, a formulation is present from the intake of the multishaft screw machine up to a distance of twice the internal housing diameter upstream of the first screw element that is not a conveying element; after the first screw element that is not a conveying element, a plastic mass is present. In the length section of the multishaft screw machine covered by the conveying elements from a distance of twice the internal housing diameter up to just before the end of the first screw element that is not a conveying element, the formulation is converted to the plastic mass.

For the purposes of the present invention, “polycarbonate” means both homopolycarbonates and copolycarbonates. These polycarbonates may be linear or branched in a familiar manner. According to the invention, it is also possible to use mixtures of polycarbonates.

A proportion up to 80 mol %, preferably from 20 mol % up to 50 mol %, of the carbonate groups in the polycarbonates used according to the invention may have been replaced by preferably aromatic dicarboxylic ester groups. Polycarbonates of this kind that incorporate both acid moieties from the carbonic acid and acid moieties from preferably aromatic dicarboxylic acids into the molecular chain are referred to as aromatic polyester carbonates.

The replacement of the carbonate groups by the aromatic dicarboxylic ester groups occurs essentially stoichiometrically and also quantitatively, which means that the molar ratio of the coreactants is reflected in the finished polyester carbonate too. The aromatic dicarboxylic ester groups may be incorporated either randomly or in blocks.

The thermoplastic polycarbonates including the thermoplastic polyester carbonates have average molecular weights Mw determined by GPC (gel-permeation chromatography in methylene chloride with polycarbonate as standard) of 15 kg/mol to 50 kg/mol, preferably of 20 kg/mol to 35 kg/mol, more preferably of 23 kg/mol to 33 kg/mol.

The preferred aromatic polycarbonates and aromatic polyester carbonates are prepared in a known manner from diphenols, carbonic acid or carbonic acid derivatives and, in the case of the polyester carbonates, preferably aromatic dicarboxylic acids or dicarboxylic acid derivatives, optionally chain terminators and branching agents.

Details of the preparation of polycarbonates have been set out in many patent specifications over the past 40 years or so. Reference may be made here by way of example to Schnell, “Chemistry and Physics of Polycarbonates”, Polymer Reviews, volume 9, Interscience Publishers, New York, London, Sydney 1964, to D. Freitag, U. Grigo, P. R. Müller, H. Nouvertné, Bayer AG, “Polycarbonates” in Encyclopedia of Polymer Science and Engineering, volume 11, second edition, 1988, pages 648-718, and lastly to U. Grigo, K. Kirchner and P. R. Müller “Polycarbonate” [Polycarbonates] in Becker/Braun, Kunststoff-Handbuch [Plastics Handbook], volume 3/1, “Polycarbonate, Polyacetale, Polyester, Celluloseester” [Polycarbonates, polyacetals, polyesters, cellulose esters], Carl Hanser Verlag Munich, Vienna 1992, pages 117-299.

Aromatic polycarbonates and polyestercarbonates are prepared, for example, by reacting diphenols with carbonyl halides, preferably phosgene, and/or with aromatic dicarbonyl halides, preferably benzenedicarbonyl halides, by the interfacial process, optionally with use of chain terminators and optionally with use of trifunctional or more than trifunctional branching agents, with preparation of the polyestercarbonates by replacing a portion of the carbonic acid derivatives with aromatic dicarboxylic acids or derivatives of the dicarboxylic acids, and with aromatic dicarboxylic ester structural units according to the carbonate structural units to be replaced in the aromatic polycarbonates. Preparation via a melt polymerization process by reaction of diphenols with for example diphenyl carbonate is likewise possible.

Dihydroxyaryl compounds suitable for producing polycarbonates are those of formula (1)

HO—Z—OH (1)
in which
Z is an aromatic radical which has 6 to 30 carbon atoms, may contain one or more aromatic rings, may be substituted and may contain aliphatic or cycloaliphatic radicals or alkylaryls or heteroatoms as bridging elements.

It is preferable for Z in formula (1) to be a radical of formula (2)

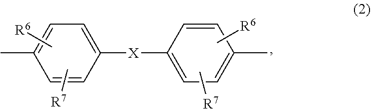

in which
R6 and R7 independently represent H, C1 to C18 alkyl, C1 to C18 alkoxy, halogen such as Cl or Br or in each case optionally substituted aryl or aralkyl, preferably H or C1 to C12 alkyl, more preferably H or C₁ to C₈ alkyl, and even more preferably H or methyl, and
X represents a single bond, —SO2-, —CO—, —O—, —S—, C1- to C6 alkylene, C₂ to C₅ alkylidene or C5 to C6 cycloalkylidene, which may be substituted by C1 to C6 alkyl, preferably methyl or ethyl, or else represents C6 to C12 arylene, which may optionally be fused to further aromatic rings containing heteroatoms.

It is preferable when X represents a single bond, C1 to C5 alkylene, C2 to C5 alkylidene, C5 to C6 cycloalkylidene, —O—, —SO—, —CO—, —S—, —SO2-
or a radical of formula (2a)

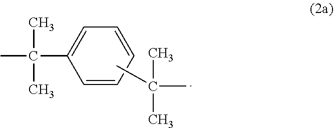

Examples of diphenols suitable for production of the polycarbonates include hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or of phenolphthalein and the ring-alkylated, ring-arylated, and ring-halogenated compounds thereof.

Preferred bisphenols are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl) propane (bisphenol A (BPA)), 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl) propane, bis(3,5-dimethyl-4-hydroxyphenyl) methane, 2,2-bis(3,5-dimethyl-4-hydroxyphenyl) propane, bis(3,5-dimethyl-4-hydroxyphenyl) sulfone, 2,4-bis(3,5-dimethyl-4-hydroxyphenyl)-2-methylbutane, 1,3-bis[2-(3,5-dimethyl-4-hydroxyphenyl)-2-propyl]benzene, 1,1-bis(4-hydroxyphenyl)cyclohexane, and 1,1-bis(4-hydroxyphenyl)-3,3,5-trimethylcyclohexane (bisphenol TMC (BPTMC)), and also the bisphenols of formulas (IV) to (VI)

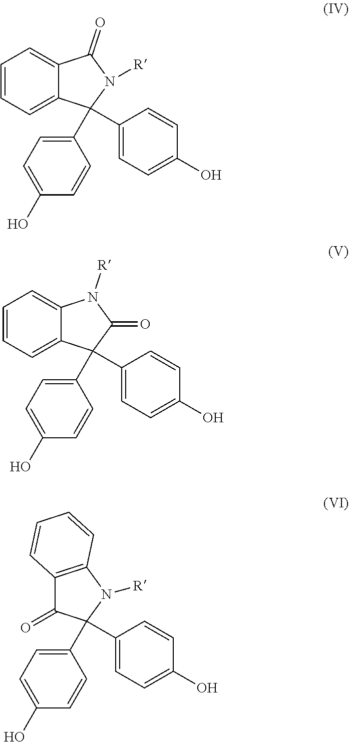

where R′ in each case represents C₁-C₄-alkyl, aralkyl or aryl, preferably methyl or phenyl.

Particularly preferred bisphenols are 4,4′-dihydroxydiphenyl, 1,1-bis(4-hydroxyphenyl)phenylethane, 2,2-bis(4-hydroxyphenyl) propane (bisphenol A (BPA)), 2,2-bis(3,5-dimethyl-4-hydroxyphenyl) propane, 1,1-bis(4-hydroxyphenyl)cyclohexane and 1,1-bis(4-hydroxyphenyl)-3,3,5-trimethylcyclohexane (bisphenol TMC (BPTMC)), and the dihydroxy compounds of formulas (IV), (V), and (VI), where R′ in each case represents C₁ to C₄ alkyl, aralkyl or aryl, preferably methyl or phenyl.

These and other suitable diphenols are described for example in U.S. Pat. Nos. 3,028,635, 2,999,825, 3,148,172, 2,991,273, 3,271,367, 4,982,014, and 2,999,846, in DE-A 1 570 703, DE-A 2 063 050, DE-A 2 036 052, DE-A 2 211 956, and DE-A 3 832 396, in FR-A 1 561 518, in the monograph “H. Schnell, Chemistry and Physics of Polycarbonates, Interscience Publishers, New York 1964” and also in JP-A 62039/1986, JP-A 62040/1986, and JP A 105550/1986.

Only one diphenol is used in the case of homopolycarbonates; two or more diphenols are used in the case of copolycarbonates. The diphenols used, like all other chemicals and auxiliaries added to the synthesis, may be contaminated with the impurities from their own synthesis, handling, and storage. However, it is desirable to use raw materials of the highest possible purity.

In particular, the polycarbonates according to the invention are composed solely of atoms selected from one or more of the elements carbon (C), hydrogen (H), oxygen (O), nitrogen (N), sulfur(S), chlorine (Cl), and bromine (Br).

Examples of suitable carbonic acid derivatives include phosgene or diphenyl carbonate.

Suitable chain terminators that may be used in the preparation of the polycarbonates are monophenols. Examples of suitable monophenols include phenol itself, alkylphenols such as cresols, p-tert-butylphenol, cumylphenol, and mixtures thereof.

Preferred chain terminators are the phenols that are monosubstituted or polysubstituted by linear or branched, preferably unsubstituted C₁ to C30 alkyl radicals or by tert-butyl. Particularly preferred chain terminators are phenol, cumylphenol and/or p-tert-butylphenol.

The amount of chain terminator to be used is preferably 0.1 to 5 mol %, based on moles of diphenols used in each case. The chain terminators may be added before, during or after the reaction with a carbonic acid derivative.

Suitable branching agents are the trifunctional or more than trifunctional compounds known in polycarbonate chemistry, in particular those having three or more than three phenolic OH groups.

Examples of suitable branching agents include 1,3,5-tri (4-hydroxyphenyl)benzene, 1,1,1-tri (4-hydroxyphenyl) ethane, tri (4-hydroxyphenyl)phenylmethane, 2,4-bis(4-hydroxyphenylisopropyl) phenol, 2,6-bis(2-hydroxy-5′-methylbenzyl)-4-methylphenol, 2-(4-hydroxyphenyl)-2-(2,4-dihydroxyphenyl) propane, tetra(4-hydroxyphenyl) methane, tetra(4-(4-hydroxyphenylisopropyl) phenoxy) methane and 1,4-bis((4′,4″-dihydroxytriphenyl)methyl)benzene and 3,3-bis(3-methyl-4-hydroxyphenyl)-2-oxo-2,3-dihydroindole.

The amount of the branching agents for optional use is preferably 0.05 mol % to 2.00 mol %, based on moles of diphenols used in each case.

The branching agents may either be initially charged together with the diphenols and the chain terminators in the aqueous alkaline phase or be added as a solution in an organic solvent before the phosgenation. In the case of the transesterification process, the branching agents are used together with the diphenols.

Particularly preferred polycarbonates are the homopolycarbonate based on bisphenol A, the homopolycarbonate based on 1,3-bis(4-hydroxyphenyl)-3,3,5-trimethylcyclohexane, and the copolycarbonates based on the monomer bisphenol A on one side and a monomer selected from the group comprising 1,1-bis(4-hydroxyphenyl)-3,3,5-trimethylcyclohexane and the bisphenols of formulas (IV) to (VI)

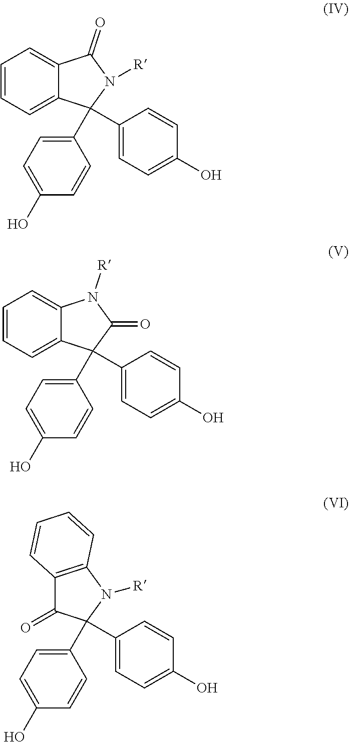

where R′ in each case represents C₁ to C₄ alkyl, aralkyl or aryl, preferably methyl or phenyl on the other side.

Preferred ways of producing the polycarbonates to be used according to the invention, including the polyester carbonates, are the known interfacial process and the known melt transesterification process (cf. e.g. WO 2004/063249 A1, WO 2001/05866 A1, WO 2000/105867, U.S. Pat. Nos. 5,340,905 A, 5,097,002 A, 5,717,057 A).

Most preferred as polycarbonate is aromatic polycarbonate based on bisphenol A, especially a linear aromatic polycarbonate based on bisphenol A.

The proportion of polycarbonate in the formulation for production of the plastic mass is from 20% to 98% by weight, especially 40% to 80% by weight.

If one thermoplastic component of the at least two thermoplastic components of the formulation according to the invention is not a polycarbonate or possibly further thermoplastic components of the formulation according to the invention are not polycarbonates, the further thermoplastic component or the possibly further thermoplastic components is or are independently selected from the group comprising the following members:

polyester carbonate, polyamide, polyesters, in particular polybutylene terephthalate and polyethylene terephthalate, polylactides, polyethers, thermoplastic polyurethane, polyacetal, fluoropolymer, in particular polyvinylidene fluoride, polyether sulfones, polyolefin, in particular polyethylene and polypropylene, polyimide, polyacrylate, in particular poly(methyl) methacrylate, polyphenylene oxide, polyphenylene sulfide, polyether ketone, polyaryl ether ketone, styrene polymers, in particular polystyrene, styrene copolymers, in particular styrene-acrylonitrile copolymer, rubber-modified vinyl (co) polymers and polyvinylchloride.

If the thermoplastic component present in the formulation is one such thermoplastic component or two or more thermoplastic components that is/are not polycarbonate(s), it is preferable according to the invention that this/these thermoplastic component(s) is/are selected from the group of the rubber-modified vinyl (co) polymers.

In other words: in a particular embodiment of the present invention, the formulation for production of the plastic mass, in addition to at least one thermoplastic component that is a polycarbonate, frequently also referred to as component A in this context, contains at least one thermoplastic component that is a rubber-modified vinyl (co) polymer, also called component B here.

The rubber-modified vinyl (co) polymers used with preference according to the invention contain rubber-based graft polymers and optionally rubber-free vinyl (co) polymers.

The graft polymers used in component B according to the invention comprise
B.1 5% to 95% by weight, preferably 20% to 92% by weight, in particular 30% to 91% by weight, based on the graft polymer, of at least one vinyl monomer,
B.2 95% to 5% by weight, preferably 80% to 8% by weight, in particular 70% to 9% by weight, based on the graft polymer of one or more rubber-elastic graft substrates having glass transition temperatures<−50° C., further preferably <−60° C., especially preferably <−70° C.

Unless expressly stated otherwise in the present invention, the glass transition temperature is determined for all components by differential scanning calorimetry (DSC) according to DIN EN 61006 (1994 version) at a heating rate of 10 K/min with determination of Tg as the midpoint temperature (tangent method).

The graft substrate B.2 generally has a median particle size (D50) of 0.05 to 10.00 μm, preferably of 0.1 to 5.0 μm, and more preferably of 0.2 to 1.5 μm.

The median particle size D50 is the diameter with 50% by weight of the particles above it and 50% by weight below it. Unless expressly stated otherwise in the present invention, it is determined for all components by means of ultracentrifuge measurement (W. Scholtan, H. Lange, Kolloid, Z. und Z. Polymere 250 (1972), 782-1796).

The monomers B.1 are preferably mixtures of:
B.1.1 65% to 85% by weight, more preferably 70% to 80% by weight, further preferably 74% to 78% by weight, based in each case on the sum of B.1.1 and B.1.2, of vinylaromatics and/or ring-substituted vinylaromatics (such as styrene, «-methylstyrene, p-methylstyrene, p-chlorostyrene) and/or (C1-C8)-alkyl (meth)acrylates, such as methyl methacrylate, ethyl methacrylate, and
B.1.2 15% to 35% by weight, more preferably 20% to 30% by weight, further preferably 22% to 26% by weight, based in each case on the sum total of B.1.1 and B.1.2, of vinyl cyanides (unsaturated nitriles such as acrylonitrile and methacrylonitrile) and/or (C1-C8)-alkyl (meth)acrylates, such as methyl methacrylate, n-butyl acrylate, t-butyl acrylate, and/or derivatives (such as anhydrides and imides) of unsaturated carboxylic acids, for example maleic anhydride.

Preferred monomers B.1.1 are selected from at least one of the monomers styrene, cx-methylstyrene and methyl methacry late; preferred monomers B.1.2 are selected from at least one of the monomers acrylonitrile, maleic anhydride and methyl methacrylate. Particularly preferred monomers are B.1.1 styrene and B.1.2 acrylonitrile. Alternatively preferred monomers are B.1.1 methyl methacrylate and B.1.2 methyl methacrylate.

Suitable graft substrates B.2 of the graft polymers include, for example, diene rubbers, EP (D) M rubbers, i.e. those based on ethylene/propylene and optionally diene, acrylate, polyurethane, silicone, chloroprene, ethylene/vinyl acetate and acrylate-silicone composite rubbers.

Preferred graft substrates B.1.2 are diene rubbers, preferably containing butadiene or copolymers of dienes, preferably containing butadiene, and further copolymerizable vinyl monomers (e.g. according to B.1.1 and B.1.2) or mixtures of one or more of the aforementioned components.

A particularly preferred graft substrate B.2 is pure polybutadiene rubber. In a further preferred embodiment, B.2 is styrene-butadiene rubber, more preferably styrene-butadiene block copolymer rubber.

The gel content of the graft substrate B.2 is at least 30% by weight, preferably at least 40% by weight, especially at least 60% by weight, based in each case on B.2 and measured as the insoluble fraction in toluene.

The gel content of the graft substrate B.2/of the graft polymers in component B is determined at 25° C. in a suitable solvent as content insoluble in these solvents (M. Hoffmann, H. Krömer, R. Kuhn, Polymeranalytik I und II, Georg Thieme-Verlag, Stuttgart 1977).

Suitable polymers of component B are, for example, ABS polymers or MBS polymers, as described, for example, in DE-A 2 035 390 (=U.S. Pat. No. 3,644,574) or in DE-A 2 248 242 (=GB-A 1 409 275), or in Ullmanns Enzyklopädie der Technischen Chemie [Ullmann's Encyclopedia of Industrial Chemistry], vol. 19 (1980), p. 280 ff.

The graft copolymers in component B are produced by free-radical polymerization, for example by emulsion, suspension, solution or bulk polymerization. Mixtures of graft polymers produced in different processes may also be used as component B.

When the graft polymers B are produced in emulsion polymerization, these comprise
B.1 5% to 75% by weight, preferably 20% to 60% by weight, more preferably 25% to 50% by weight, based on the graft polymer, of at least one vinyl monomer,
B.2 95% to 25% by weight, preferably 80% to 40% by weight, more preferably 75% to 50% by weight, based on the graft polymer, of one or more rubber-elastic graft substrates having glass transition temperatures<−50° C., further preferably <−60° C., especially preferably <−70° C.

The graft substrate B.2 of graft polymers B produced in emulsion polymerization have a median particle size (D50) of 0.05 to 2.00 μm, preferably of 0.1 to 1.0 μm, more preferably of 0.2 to 0.5 μm.

Graft polymers B produced in emulsion polymerization have a gel content, measured in acetone as solvent, of preferably at least 30% by weight, more preferably of at least 60% by weight, further preferably of at least 80% by weight.

When the graft polymers B are produced in suspension, solution or bulk polymerization, these comprise:
B.1 80% to 95% by weight, preferably 84% to 92% by weight, more preferably 87% to 91% by weight, based on the graft polymer, of at least one vinyl monomer,
B.2 20% to 5% by weight, preferably 16% to 8% by weight, more preferably 13% to 9% by weight, based on the graft polymer, of one or more rubber-elastic graft substrates having glass transition temperatures<−50° ° C., further preferably <−60° C., especially preferably <−70° C.

The graft substrate B.2 of graft polymers B produced in suspension, solution or bulk polymerization have a median particle size (D50) of 0.3 to 10.00 μm, preferably of 0.4 to 5.0 μm, more preferably of 0.5 to 1.5 μm.

Graft polymers B produced in suspension, solution or bulk polymerization have a gel content, measured in acetone as solvent, of preferably 10 to 50% by weight, more preferably of 15 to 40% by weight, further preferably of 18 to 30% by weight.

Particularly suitable graft polymers produced by the emulsion polymerization process are for example ABS polymers produced in the emulsion polymerization process by redox initiation with an initiator system composed of organic hydroperoxide and ascorbic acid according to U.S. Pat. No. 4,937,285.

Further particularly suitable graft polymers produced in the emulsion polymerization process are MBS modifiers having a core-shell structure.

Component B may contain free vinyl (co) polymer composed of the monomers according to B.1, i.e. in a form not chemically bonded to the rubber substrate and not included in the rubber particles. This may arise in component B as a result of production in the polymerization of the graft polymers (grafting onto the graft substrate is not always complete), or else may be the result of separate polymerization and inclusion in component B. It is likewise possible for a portion of the free vinyl (co) polymer in component B to originate from the graft polymers themselves as a result of production and for another portion to be polymerized separately and added to component B. The proportion of the free vinyl (co) polymer (irrespective of its origin), measured as the acetone-soluble fraction, in component B is preferably at least 5% by weight, more preferably at least 30% by weight, especially preferably at least 50% by weight, based on component B.

This free vinyl (co) polymer in the rubber-modified vinyl copolymers according to component B has a weight-average molecular weight Mw of 30 to 250 kg/mol, preferably of 70 to 200 kg/mol, in particular of 90 to 180 kg/mol.

In the context of the present invention, the weight average molecular weight Mw of the free vinyl (co) polymer in component B is measured by gel permeation chromatography (GPC) in tetrahydrofuran against a polystyrene standard.

The formulation for production of the plastic mass may contain the at least two thermoplastic components in pure form or as mixtures with fillers and reinforcers, such as, in particular, glass fibers or talc.

In a preferred embodiment, one or more additives is or are added to the formulation. A particular additive may be a solid, a liquid or a solution and may—optionally with one further additive or two or more further additives where present—be added to the multishaft screw machine together with the formulation, or else it is fed into the multishaft screw machine-optionally with one further additive or two or more further additives where present-via a separate sidestream.

Additives can impart a variety of properties to a polymer. These may be, for example, colorants, pigments, processing aids, fillers, antioxidants, reinforcers, UV absorbers and light stabilizers, metal deactivators, peroxide scavengers, basic stabilizers, nucleating agents, benzofurans and indolinones which have a stabilizing or antioxidant effect, mold release agents, flame retardant additives, antistats, dyes and melt stabilizers. Examples of these are carbon black, glass fibers, clay, mica, graphite fibers, titanium dioxide, carbon fibers, carbon nanotubes, ionic liquids and natural fibers. Suitable additives are described, for example, in: WO 99/55772, p. 15-25, in “Plastics Additives”, R. Gächter and H. Müller, Hanser Publishers 1983, in “Additives for Plastics Handbook, John Murphy, Elsevier, Oxford 1999”, in “Plastics Additives Handbook, Hans Zweifel, Hanser, Munich 2001”.

Preferably according to the invention, it is possible to add an additive that is free-flowing at 23° C. to the plastic mass, or it is possible to add a plurality of additives that are free-flowing at 23° C. to the plastic mass, for example two, three or four such additives that are free-flowing at 23° C.

Particular preference is given according to the invention to a phosphorus-containing flame retardant as an additive that is free-flowing at 23° C.

Phosphorus-containing flame retardants in the context according to the invention are preferably selected from the groups of the mono- and oligomeric phosphoric and phosphonic esters, phosphazenes and salts of phosphinic acid, and it is also possible to use mixtures of a plurality of compounds selected from one group or various groups among these as flame retardants. It is also possible to use other phosphorus compounds that have not been mentioned here specifically, alone or in any desired combination with other phosphorus compounds.

Preferred mono- and oligomeric phosphoric and phosphonic esters are phosphorus compounds of the general formula (III)

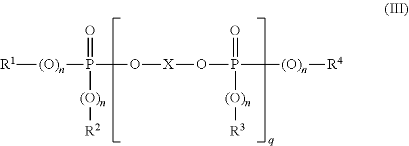

in which
R1, R2, R3 and R4 are each independently optionally halogenated C1 to C8-alkyl, respectively optionally alkyl-substituted, preferably C1- to C4-alkyl-substituted, and/or halogen-substituted, preferably chlorine- or bromine-substituted, C5 to C6-cycloalkyl, C6 to C20-aryl or C7 to C12-aralkyl,
n is independently 0 or 1,
q is 0 to 30 and
X is a mono- or polycyclic aromatic radical having 6 to 30 carbon atoms, or a linear or branched aliphatic radical having 2 to 30 carbon atoms, which may be OH-substituted and may contain up to 8 ether bonds.
It is preferable that R1, R2, R3 and R4 independently represent C1 to C4-alkyl, phenyl, naphthyl or phenyl-C1-C4-alkyl. The aromatic R1, R2, R3 and R4 groups may in turn be substituted by halogen and/or alkyl groups, preferably chlorine, bromine and/or C1 to C4-alkyl. Particularly preferred aryl radicals are cresyl, phenyl, xylenyl, propylphenyl or butylphenyl, and the corresponding brominated and chlorinated derivatives thereof.

X in the formula (III) is preferably a mono- or polycyclic aromatic radical having 6 to 30 carbon atoms. The latter is preferably derived from diphenols.

n in the formula (III) may independently be 0 or 1; n is preferably 1.

q has values of 0 to 30. When mixtures of different components of the formula (III) are used, mixtures may preferably have number-average q values of 0.3 to 10, more preferably 0.5 to 10, especially 1.05 to 1.4.

X is more preferably

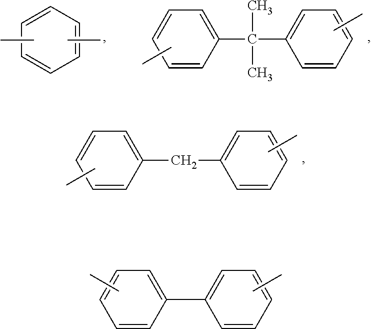

or the chlorinated or brominated derivatives thereof; in particular, X is derived from resorcinol, hydroquinone, bisphenol A or diphenylphenol. Particularly preferably, X is derived from bisphenol A.

Monophosphates (q=0), oligophosphates (q=1-30) or mixtures of mono- and oligophosphates may be used as component C according to the invention.

Monophosphorus compounds of the formula (III) are especially tributyl phosphate, tris(2-chloroethyl) phosphate, tris(2,3-dibromopropyl) phosphate, triphenyl phosphate, tricresyl phosphate, diphenyl cresyl phosphate, diphenyl octyl phosphate, diphenyl 2-ethylcresyl phosphate, tri (isopropylphenyl) phosphate, halogen-substituted aryl phosphates, dimethyl methylphosphonate, diphenyl methylphosphenate, diethyl phenylphosphonate, triphenylphosphine oxide or tricresylphosphine oxide.

Most preferred as component D is bisphenol A-based oligophosphate of formula (IIIa):

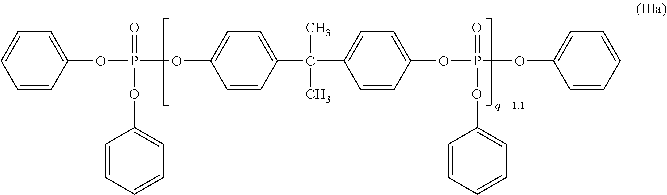

The phosphorus compounds of formula (III) are known (cf., for example, EP-A 363 608, EP-A 640 655) or can be prepared in an analogous manner by known methods (e.g. Ullmanns Enzyklopädie der technischen Chemie, vol. 18, p. 301 ff. 1979; Houben-Weyl, Methoden der organischen Chemie [Methods of Organic Chemistry], vol. 12/1, p. 43; Beilstein vol. 6, p. 177). A particular example selected from the phosphorus compounds of formula (III) is bisphenol A bis(diphenylphosphate), also called BDP for short. This BDP is also preferred as an additive that is free-flowing at 23° C.

The average q values can be determined by using a suitable method (gas chromatography (GC), high pressure liquid chromatography (HPLC), gel permeation chromatography (GPC)) to determine the composition of the phosphate mixture (molecular weight distribution) and using this to calculate the average values for q.

Phosphazenes are compounds of the formulae (IVa) and (IVb)

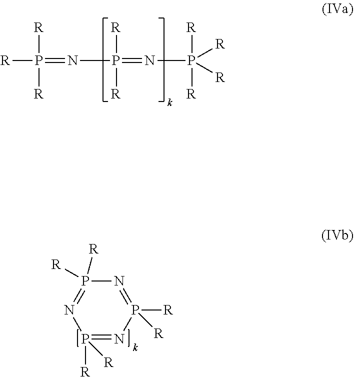

in which
R is the same or different in each case and is amino, in each case optionally halogenated, preferably fluorinated, C1- to C8-alkyl, or C1- to C8-alkoxy, in each case optionally alkyl-substituted, preferably C1- to C4-alkyl-substituted, and/or halogen-substituted, preferably chlorine- and/or bromine-substituted, C5- to C6-cycloalkyl, C6- to C20-aryl, preferably phenyl or naphthyl, C6- to C20-aryloxy, preferably phenoxy, naphthyloxy, or C7- to C12-aralkyl, preferably phenyl-C1-C4-alkyl,
k is 0 or a number from 1 to 15, preferably a number from 1 to 10.

Examples include propoxyphosphazene, phenoxyphosphazene, methylphenoxyphosphazene, aminophosphazene and fluoroalkylphosphazenes. Phenoxyphosphazene is preferred.

The phosphazenes can be used alone or in a mixture. The R radical may always be the same, or 2 or more radicals in the formulae (IVa) and (IVb) may be different. Phosphazenes and the production thereof are described for example in EP-A 728 811, DE-A 1 961668 and WO 97/40092.

The salt of a phosphinic acid in the context according to the invention is understood to mean the salt of a phosphinic acid with any metal cation. It is also possible to use mixtures of salts which differ in terms of their metal cation. The metal cations are the cations of the metals of main group 1 (alkali metals, preferably Li+, Na+, K+), of main group 2 (alkaline earth metals, preferably Mg2+, Ca2+, Sr2+, Ba2+, more preferably Ca2+) or of main group 3 (elements of the boron group, preferably A13+) and/or of transition group 2, 7 or 8 (preferably Zn2+, Mn2+, Fe2+, Fe3+) of the Periodic Table.

Preference is given to using a salt or a mixture of salts of a phosphinic acid of the formula (V)

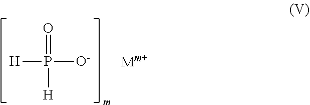

in which Mm+ is a metal cation of main group 1 (alkali metals; m=1), of main group 2 (alkaline earth metals; m=2) or of main group 3 (m=3) or of transition group 2, 7 or 8 (where m is an integer from 1 to 6, preferably 1 to 3 and more preferably 2 or 3) of the Periodic Table.

More preferably, in formula (V),
when m=1 the metal cations M+=Li+, Na+, K+,
when m=2 the metal cations M2+=Mg2+, Ca2+, Sr2+, Ba2+ and
when m=3 the metal cations M3+=Al3+;
most preferred is Ca2+ (m=2).

In a preferred embodiment, the median particle size d50 of the phosphinic salt (component C) is less than 80 μm, preferably less than 60 μm; more preferably, d50 is between 10 μm and 55 μm. The median particle size d50 is the diameter with 50% by weight of the particles above it and 50% by weight below it. It is also possible to use mixtures of salts which differ in terms of their median particle size d50.

This additive that is free-flowing at 23° C. and is particularly preferred according to the invention, further according to the invention, is preferably added to the plastic mass via a sidestream from the last conveying element before the first screw element that is not a conveying element. More preferably, this additive that is free-flowing at 23° C. and is particularly preferred according to the invention is added to the plastic mass downstream of the last conveying element before the first screw element that is not a conveying element. Most preferably, this additive that is free-flowing at 23° C. and is particularly preferred according to the invention is added to the plastic mass downstream of the melting zone.

Examples of suitable antioxidants/thermal stabilizers include:
alkylated monophenols, alkylthiomethylphenols, hydroquinones and alkylated hydroquinones, tocopherols, hydroxylated thiodiphenyl ethers, alkylidenebisphenols, O—, N- and S-benzyl compounds, hydroxybenzylated malonates, aromatic hydroxybenzyl compounds, triazine compounds, acylaminophenols, esters of β-(3,5-di-tert-butyl-4-hydroxyphenyl) propionic acid, esters of β-(5-tert-butyl-4-hydroxy-3-methylphenyl) propionic acid, esters of β-(3,5-dicyclohexyl-4-hydroxyphenyl) propionic acid, esters of 3,5-di-tert-butyl-4-hydroxyphenylacetic acid, amides of β-(3,5-di-tert-butyl-4-hydroxyphenyl) propionic acid, suitable thio synergists, secondary antioxidants, phosphites and phosphonites, benzofuranones, and indolinones.

Preference is given to organic phosphites, phosphonates, and phosphanes, mostly those in which the organic radicals consist completely or partially of optionally substituted aromatic radicals.

Suitable complexing agents for heavy metals and for the neutralization of traces of alkalis are ortho- and metaphosphoric acids, fully or partly esterified phosphates or phosphites.

Suitable light stabilizers (UV absorbers) are 2-(2′-hydroxyphenyl)benzotriazoles, 2-hydroxybenzophenones, esters of substituted and unsubstituted benzoic acids, acrylates, sterically hindered amines, oxamides and also 2-(hydroxyphenyl)-1,3,5-triazines and substituted hydroxyalkoxyphenyl-1,3,5-triazoles, preference being given to substituted benzotriazoles, for example 2-(2′-hydroxy-5′-methylphenyl)benzotriazole, 2-(2′-hydroxy-3′,5′-di-t-butylphenyl)benzotriazole, 2-(2′-hydroxy-3′-tert-butyl-5′-methylphenyl)-5-chlorobenzotriazole, 2-(2′-hydroxy-3′,5′-tert-butylphenyl)-5-chlorobenzotriazole, 2-(2′-hydroxy-5′-tert-octylphenyl)benzotriazole, 2-(2′-hydroxy-3′,5′-di-tert-amylphenyl)benzotriazole, 2-[2′-hydroxy-3′-(3″,4″,5″,6″-tetrahydrophthalimidoethyl)-5′-methylphenyl] benzotriazole, and 2,2′-methylenebis[4-(1,1,3,3-tetramethylbutyl)-6-(2H-benzotriazol-2-yl) phenol].

Polypropylene glycols, alone or in combination with, for example, sulfones or sulfonamides as stabilizers, may be used to counteract damage by gamma rays.

These and other stabilizers may be used individually or in combinations and may be added to the formulation according to the invention in the stated forms.

It is also possible to add processing aids such as demolding agents, mostly derivatives of long-chain fatty acids. Preference is given for example to pentaerythritol tetrastearate and glycerol monostearate. These are used on their own or as mixtures.

Suitable flame retardant additives are phosphate esters, i.e. triphenyl phosphate, resorcinol diphosphate, brominated compounds, such as brominated phosphoric esters, brominated oligocarbonates and polycarbonates, and preferably salts of fluorinated organic sulfonic acids.

Suitable impact modifiers are butadiene rubber with grafted-on styrene-acrylonitrile or methyl methacry late, ethylene-propylene rubbers with grafted-on maleic anhydride, ethyl and butyl acrylate rubbers with grafted-on methyl methacrylate or styrene-acrylonitrile, interpenetrating siloxane and acrylate networks with grafted-on methyl methacrylate or styrene-acrylonitrile.

In addition, it is possible to add colorants such as organic dyes or pigments or inorganic pigments, IR absorbers, individually, as mixtures or else in combination with stabilizers, glass fibers, (hollow) glass beads, and inorganic, in particular mineral, fillers, these mineral fillers also including reinforcing fillers, especially titanium dioxide (TiO₂), talc (Mg₃Si₄O₁₀(OH)₂), dolomite CaMg[CO₃]₂, kaolinite Al₄[(OH)₈|Si₄O₁₀], and wollastonite Ca₃[Si₃O₉], very especially titanium dioxide (TiO₂) and talc (Mg₃Si₄O₁₀(OH)₂).

The produced plastic mass according to the invention can be used wherever already known plastic masses containing at least two thermoplastic components, at least one of which is a polycarbonate, are used.

The present invention also provides a plastic mass produced by the process according to the invention.

The invention further provides for the use of the plastic mass produced according to the invention for production of shaped articles.

The plastic mass produced according to the invention can be used for production of any kind of shaped articles. These may be produced for example by injection molding, extrusion, and blow-molding processes. A further form of processing is the production of molded articles by thermoforming from previously produced sheets or films.

Examples of such shaped articles that can be produced from the formulations and plastic masses according to the invention are films, profiles, housing parts of any kind, for example for domestic appliances such as juice presses, coffee machines, mixers; for office machinery such as monitors, flatscreens, notebooks, printers, copiers; sheets, pipes, electrical installation ducts, windows, doors and other profiles for the construction sector (internal fitout and external applications) and also electrical and electronic components such as switches, plugs and sockets, and parts for commercial vehicles, in particular for the automotive sector. The formulations and plastic masses according to the invention are also suitable for production of the following shaped articles or moldings: ships, aircraft, buses and other motor vehicles, bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, moulded parts for sanitation and bathroom equipment, protective grilles for ventilation openings and housings for garden equipment.

The invention is elucidated hereinbelow with reference to examples, without any intention that the invention be limited to these examples.

### EXAMPLES

Determination of Average Dwell Times t₁ and t₂

The average dwell times t₁ and t₂ in the extruder were determined as described hereinafter.

First of all, the desired speed was set on the extruder, and the extruder was supplied with all the formulation components at the desired sites and with the desired throughput. 10 minutes after completion of addition of all formulation components, the extruder was supplied manually, as pulse tracer, with 1 gram of tracer pellets (Makrolon 2805 in color 901510 [corresponding to black]) per 50 kg/h of total throughput of the formulation.

For determination of average dwell time t₁ in the case of formulations without additive that is free-flowing at 23° C., the tracer pellets were added to an opening in the extruder housing at a distance of twice the internal housing diameter (2D) upstream of the first screw element that is not a conveying element.

For determination of average dwell time t₂ in the case of formulations with additive that is free-flowing at 23° C., the tracer pellets were added to an opening in the extruder housing that is axially parallel to the addition site for the additive that is free-flowing at 23° C.

The dwell time t₁ in the case of formulations with the additive that is free-flowing at 23° C. was calculated from the dwell time in the case of addition of the tracer pellets to the housing opening 2D upstream of the first screw element that is not a conveying element minus the dwell time in the case of addition of the tracer to the housing opening axially parallel to the addition site of the additive that is free-flowing at 23° C.

Simultaneously with the addition of the tracer pellets, time measurement was commenced.

An inline spectrophotometer (COLVISTEC InSpectro X2) was used to measure the intensity of the tracer in the plastic mass in a flange immediately downstream of the end of the extruder shafts.

For this purpose, for plastic masses having an average transmittance of less than 40% in the wavelength range between 400 nm and 800 nm, a measurement probe was mounted in the flange and the measurement was conducted in reflectance, whereas, for all other plastic masses, two opposite measurement probes were positioned in the flange and the measurement was conducted in transmittance. The measurement probes were each connected by glass fiber conduits to a spectrophotometer. The spectrophotometer was used to measure and record the color spectrum of the plastic mass between 230 nm and 800 nm every second from the addition of tracer for 5 minutes, and the L value (brightness; according to CIE LAB) was calculated.

The average dwell time was calculated from the cumulative function of the distribution curve for the L value by means of the ReTA evaluation program from COLVISTEC. For the determination of average dwell time for one experimental setting, the average was formed from 3 measurements in each case. However, it is also possible to use another suitable software package in order to work out the average dwell time from the distribution curve for the L value.

### Measurement of Melting Temperature

The melting temperature of the plastic mass in all experiments was measured by inserting a thermocouple into the middle melt strand exiting from the extruder or, in the case of an even number of nozzle holes, into one of the two middle melt strands, directly at the exit from the nozzle bar.

### Measurement of Unmelted Particles

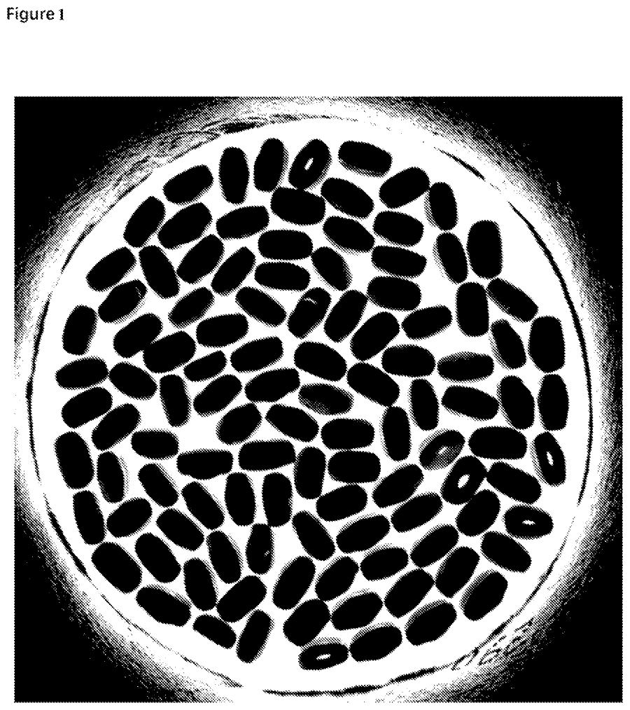

For assessment of plastification quality, for each experimental setting, a determination was made of how many of 330 pellets in each case that were selected randomly from the total number of pellets produced per experiment contain at least one unmelted particle. For this purpose, 110 pellets in each case were laid out on a lightbox such that their cut edges were aligned at right angles to the lightbox. Subsequently, a cardboard roll having a diameter of about 4 cm was placed around the pellets. A digital camera was placed at the top end of the roll. Exposure and focus were set on the camera such that the top side of the pellets was sharply imaged and the unmelted particles had good contrast from the plastic mass. FIG. 1 shows by way of example a photograph thus taken.

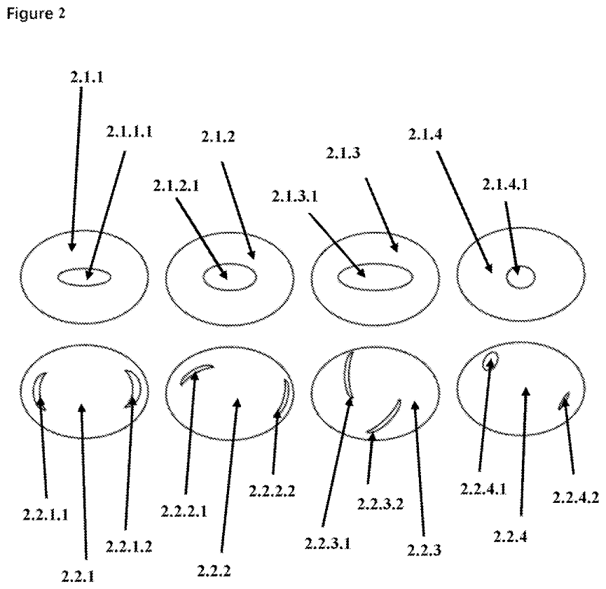

The photographs taken by the digital camera were examined visually on a monitor for unmelted particles in the pellets. In the evaluation of the images, a distinction is made between vacuoles and unmelted particles. The unmelted particles differ from vacuoles in shape and position. While vacuoles are generally at the center of the pellet, the unmelted particles are outside the center. Vacuoles are generally oval to elongated, whereas unmelted particles are much narrower and usually sickle-shaped. In FIG. 2, vacuoles and unmelted particles are distinguished by way of example. 2.1.1, 2.1.2, 2.1.3 and 2.1.4 indicate pellets having vacuoles; 2.1.1.1, 2.1.2.1, 2.1.3.1 and 2.1.4.1 indicate the vacuoles in these pellets; 2.2.1, 2.2.2, 2.2.3 and 2.2.4 indicate pellets having unmelted particles; 2.2.1.1, 2.2.1.2, 2.2.2.1, 2.2.2.2, 2.2.3.1, 2.2.3.2, 2.2.4.1 and 2.2.4.2 indicate the unmelted particles in these pellets.

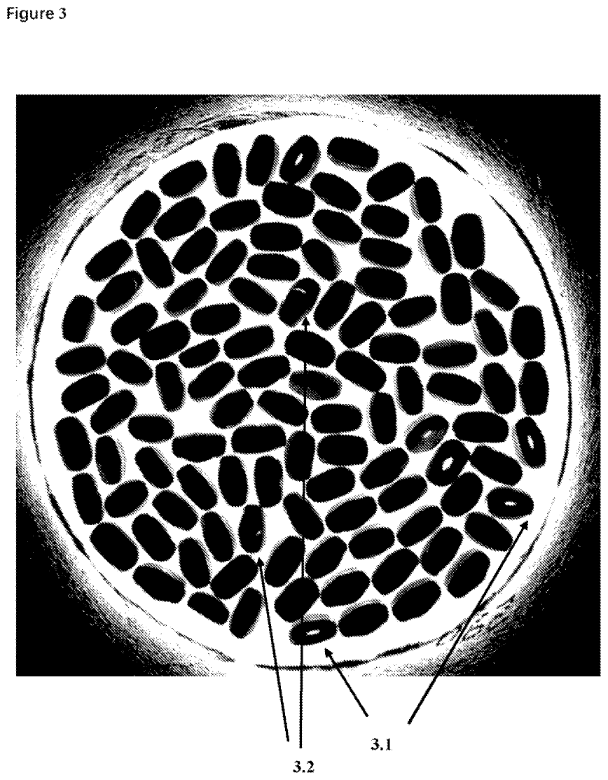

In FIG. 3, in the photograph from FIG. 1, pellets with vacuoles are labeled (3.1), and pellets with unmelted particles are labeled (3.2).

If distinction between vacuoles and unmelted particles was not possible from the digital photograph, pellets were inspected individually by eye. It is possible here to unambiguously distinguish unmelted particles from vacuoles: while vacuoles are always holes, unmelted particles are transparent inclusions that extend across the entire length of the pellet in strand drawing direction. If the pellets with unmelted particles are held against the light, reflection of light is apparent. This reflection of light does not occur in the case of vacuoles since vacuoles are filled solely with gas.

For the assessment of plastification quality, the number of pellets with at least one unmelted particle was based on the total number of pellets examined per experimental setting, i.e. 330. Five granules with unmelted particles thus means 5/330=1.5% unmelted particles.

### Examples 1-6: Variation of Process Parameters of Mass Flow Rate m and Screw Shaft Speed n

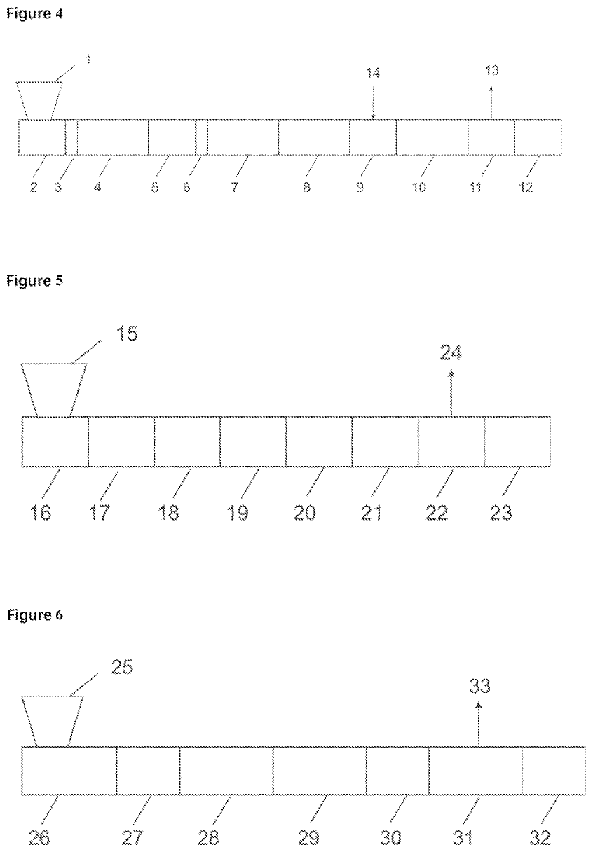

A ZE60B UTXi twin screw extruder from KraussMaffei Extrusion GmbH was used for the production of the plastic mass in examples 1-6. The design features of the extruder can be found in table 1 in columns k to n. The basic construction of the extruder used for examples 1-6 is shown in FIG. 4.

In examples 1-6, all components of the formulation were metered by means of conventional gravimetric differential metering balances via the intake funnel 1 depicted into the main intake of the screw machine in housing 2.

In the region of the housings 2 to 7 is a conveying zone for all components of the formulation.

In the region of the housing 8 is a plastifying zone, the screw configuration of which consists of various two- and three-flight kneading blocks of various width and toothed mixing elements.

In the region of the housings 9 to 10 is a mixing zone, the screw configuration of which consists of kneading elements, toothed mixing elements and conveying elements.

In housing part 11 is the vent 13, which is connected to an extraction apparatus (not shown).

In housing 12 is the pressurization zone, and downstream thereof a nozzle plate having 29 holes.

In examples 1-6, pelletization was effected in the form of strand pelletization after water-bath cooling.

The formulation which is fed into the extruder in examples 1-6 consists of a mixture of:
60.3% by weight of pellets of a linear polycarbonate based on bisphenol A having a relative viscosity ηᵣₑₗ=1.28 (measured in CH₂Cl₂ as solvent at 25° C. and at a concentration of 0.5 g/100 ml) and
17.2% by weight of emulsion ABS pellets having an A:B:S weight ratio of 20:24:56 and
8.9% by weight of bulk ABS pellets having an A:B:S weight ratio of 25:10:65 and
9.5% by weight of a styrene-acrylonitrile copolymer (SAN) having an A:S weight ratio of 24:76 and
4.1% by weight of a powder mixture containing 3% by weight of an emulsion ABS graft in powder form with an A:B:S weight ratio of 12:58:30, and 0.35% by weight of stabilizers and 0.75% by weight of demolding agents.

In comparative examples 1 and 2 and examples 3 to 6 according to the invention, the formulation is compounded with the following parameters specified in table 1: screw shaft speeds (table 1, column p), mass flow rates (table 1, column o) and the resulting specific mechanical energy inputs (table 1, column q) and temperatures of the melt exiting from the nozzle plate (table 1, column r). This results in the numbers of pellets with unmelted particles likewise given in table 1 (table 1, column w).

As shown by examples 1-6, irrespective of the speed chosen or the mass flow rate chosen for the formulation, a plastic mass according to the invention is always obtained when the melting rate (table 1, column x) is at least 1.18, especially at least 1.23, whereas, in the case of a melting rate of less than 1.18, especially in the case of a melting rate of 1.08 or less, the number of pellets with unmelted particles is unacceptable.

### Examples 7-19: Variation of Viscosity Ratios Dh₁ and Dh₂

A ZE60B UTXi twin screw extruder from KraussMaffei Extrusion GmbH was used for the production of the plastic mass in examples 7-19. The design features of the extruder can be found in table 1 in columns k to n. The basic construction of the extruder used for examples 7-19 is shown in FIG. 4.

In examples 7-10, all components of the formulation were metered by means of conventional gravimetric differential metering balances via the intake funnel 1 depicted into the main intake of the screw machine in housing 2.

In the region of the housings 2 to 7 is a conveying zone for all components of the formulation.

In the region of the housing 8 is a plastifying zone, the screw configuration of which consists of various two- and three-flight kneading blocks of various width and toothed mixing elements.

In the region of the housings 9 to 10 is a mixing zone, the screw configuration of which consists of kneading elements, toothed mixing elements and conveying elements.

In housing part 11 is the vent 13, which is connected to an extraction apparatus (not shown).

In housing 12 is the pressurization zone, and downstream thereof a nozzle plate having 29 holes.

In examples 7-10, pelletization was effected in the form of strand pelletization after water-bath cooling.

The formulation which is fed into the extruder in examples 7-10 consists of a mixture of:
76% by weight of pellets of a linear polycarbonate based on bisphenol A having a relative viscosity ηᵣₑₗ=1.28 (measured in CH₂Cl₂ as solvent at 25° C. and at a concentration of 0.5 g/100 ml) and
3.96% by weight of bulk ABS pellets having an A:B:S weight ratio of 25:10:65 and
24.74% by weight of bulk ABS pellets having an A:B:S weight ratio of 21:10:69 and
2.04% by weight of a powder mixture containing 1% by weight of an emulsion ABS graft in powder form with an A:B:S weight ratio of 12:58:30, and 0.3% by weight of stabilizers and 0.74% by weight of demolding agents.

The plastic mass in examples 7-10 has the average specific heat capacity specified in table 1, column h.

In comparative examples 7 and 8 and examples 9 and 10 according to the invention, the formulation is compounded with the following parameters specified in table 1: screw shaft speeds (table 1, column p), mass flow rates (table 1, column o) and the resulting specific mechanical energy inputs (table 1, column q) and temperatures of the melt exiting from the nozzle plate (table 1, column r). This results in the numbers of pellets with unmelted particles likewise given in table 1 (table 1, column w).

In examples 11-14, all components of the formulation, except for the additive that is free-flowing at 23° C., were metered by means of conventional gravimetric differential metering balances via the intake funnel 1 depicted into the main intake of the screw machine in housing 2.

In the region of the housings 2 to 7 is a conveying zone for all components of the formulation.

In the region of the housing 8 is a plastifying zone consisting of various two- and three-flight kneading blocks of various width and also toothed mixing elements.

In the housing 9, the additive which is free-flowing at 23° C. was injected into the plastic mass by means of a commercial membrane piston pump (not shown) via a valve (not shown) that was screwed into a hole 14 in housing 9.

In the region of the housings 9 to 10 is a mixing zone consisting of kneading elements, toothed mixing elements and conveying elements.

In housing part 11 is the vent 13, which is connected to an extraction apparatus (not shown).

In housing 12 is the pressurization zone, and downstream thereof a nozzle plate having 29 holes.

In examples 11-14, pelletization was effected in the form of strand pelletization after water-bath cooling.

The formulation which is fed into the extruder in examples 11-14 consists of a mixture of:
73% by weight of pellets of a linear polycarbonate based on bisphenol A having a relative viscosity ηᵣₑₗ=1.28 (measured in CH₂Cl₂ as solvent at 25° C. and at a concentration of 0.5 g/100 ml) and
4.7% by weight of a styrene-acrylonitrile copolymer (SAN) having an A:S weight ratio of 24:76 and
7.7% by weight of an emulsion ABS graft in powder form having an A:B:S weight ratio of 12:58:30 and
10% by weight of a bisphenol A-based oligophosphate which is free-flowing at 23° C., especially BDP, and
4.6% by weight of a powder mixture containing 3% by weight of a linear polycarbonate based on bisphenol A and having a relative viscosity ηᵣₑₗ=1.28 (measured in CH₂Cl₂ as solvent at 25° C. and at a concentration of 0.5 g/100 ml) and 0.4% by weight of stabilizers, 0.8% by weight of flame retardants, and 0.4% by weight of demolding agents.

The plastic mass in examples 11-14 has the average specific heat capacity specified in table 1, column h.

In comparative example 11 and examples 12-14 according to the invention, the formulation is compounded with the following parameters specified in table 1: screw shaft speeds (table 1, column p), mass flow rates (table 1, column o) and the resulting specific mechanical energy inputs (table 1, column q) and temperatures of the melt exiting from the nozzle plate (table 1, column r). This results in the numbers of pellets with unmelted particles likewise given in table 1 (table 1, column w).

In examples 15-19, all components of the formulation, except for the additive that is free-flowing at 23° C., were metered by means of conventional gravimetric differential metering balances via the intake funnel 1 depicted into the main intake of the screw machine in housing 2.

In the region of the housings 2 to 7 is a conveying zone for all components of the formulation.

In the region of the housing 8 is a plastifying zone consisting of various two- and three-flight kneading blocks of various width and also toothed mixing elements.

In the housing 9, the additive which is free-flowing at 23° C. was injected into the plastic mass by means of a commercial membrane piston pump (not shown) via a valve (not shown) that was screwed into a hole 14 in housing 9.

In the region of the housings 9 to 10 is a mixing zone consisting of kneading elements, toothed mixing elements and conveying elements.

In housing part 11 is the vent 13, which is connected to an extraction apparatus (not shown).

In housing 12 is the pressurization zone, and downstream thereof a nozzle plate having 29 holes.

In examples 15-19, pelletization was effected in the form of strand pelletization after water-bath cooling.

The formulation which is fed into the extruder in examples 15-19 consists of a mixture of:
40.2% by weight of pellets of a linear polycarbonate based on bisphenol A having a relative viscosity ηᵣₑₗ=1.28 (measured in CH₂Cl₂ as solvent at 25° C. and at a concentration of 0.5 g/100 ml) and
23.5% by weight of pellets of a linear polycarbonate based on bisphenol A having a relative viscosity ηᵣₑₗ=1.20 (measured in CH₂Cl₂ as solvent at 25° C. and at a concentration of 0.5 g/100 ml) and
7% by weight of a styrene-acrylonitrile copolymer (SAN) having an A:S weight ratio of 24:76 and 11% by weight of an emulsion ABS graft in powder form having an A:B:S weight ratio of 12:58:30 and
14% by weight of a bisphenol A-based oligophosphate which is free-flowing at 23° C., especially BDP, and
4.3% by weight of a powder mixture containing 3% by weight of a linear polycarbonate based on bisphenol A and having a relative viscosity ηᵣₑₗ=1.28 (measured in CH₂Cl₂ as solvent at 25° C. and at a concentration of 0.5 g/100 ml) and 0.1% by weight of stabilizers, 0.8% by weight of flame retardants, and 0.4% by weight of demolding agents.

The plastic mass in examples 15-19 has the average specific heat capacity specified in table 1, column h.

In comparative examples 15-17 and examples 18 and 19 according to the invention, the formulation is compounded with the following parameters specified in table 1:screw shaft speeds (table 1, column p), mass flow rates (table 1, column o) and the resulting specific mechanical energy inputs (table 1, column q) and temperatures of the melt exiting from the nozzle plate (table 1, column r). This results in the numbers of pellets with unmelted particles likewise given in table 1 (table 1, column w).

As shown by examples 1-6, 7-10, 11-14 and 15-19 with respectively different formulations, irrespective of the formulation or the average specific heat capacity thereof and of the chosen speed or the chosen mass flow rate, a plastic mass according to the invention is always obtained when the melting rate (table 1, column x) is at least 1.18, especially at least 1.20, whereas, in the case of a melting rate of less than 1.18, especially in the case of a melting rate of 1.14 or less, the number of pellets with unmelted particles is unacceptable.

### Examples 20-29: Variation of Pellet Diameter d

A ZE60B UTXi twin screw extruder from KraussMaffei Extrusion GmbH was used for the production of the plastic mass in examples 20-29. The design features of the extruder can be found in table 1 in columns k to n. The basic construction of the extruder used for examples 7-19 is shown in FIG. 4.

In examples 20-29, all components of the formulation, except for the additive that is free-flowing at 23° C., were metered by means of conventional gravimetric differential metering balances via the intake funnel 1 depicted into the main intake of the screw machine in housing 2.

In the region of the housings 2 to 7 is a conveying zone for all components of the formulation.

In the region of the housing 8 is a plastifying zone, the screw configuration of which consists of various two- and three-flight kneading blocks of various width and toothed mixing elements.

In the housing 9, the additive which is free-flowing at 23° C. was injected into the plastic mass by means of a commercial membrane piston pump (not shown) via a valve (not shown) that was screwed into a hole 14 in housing 9.

In the region of the housings 9 to 10 is a mixing zone, the screw configuration of which consists of kneading elements, toothed mixing elements and conveying elements.

In housing part 11 is the vent 13, which is connected to an extraction apparatus (not shown).

In housing 12 is the pressurization zone, and downstream thereof a nozzle plate having 29 holes.

In examples 20-29, pelletization was effected in the form of strand pelletization after water-bath cooling.

The formulation which is fed into the extruder in examples 20-29 consists of a mixture of:
40.2% by weight of pellets of a linear polycarbonate based on bisphenol A having a relative viscosity ηᵣₑₗ=1.28 (measured in CH₂Cl₂ as solvent at 25° C. and at a concentration of 0.5 g/100 ml) and
23.5% by weight of pellets of a linear polycarbonate based on bisphenol A having a relative viscosity ηᵣₑₗ=1.20 (measured in CH₂Cl₂ as solvent at 25° C. and at a concentration of 0.5 g/100 ml) and
7% by weight of a styrene-acrylonitrile copolymer (SAN) having an A:S weight ratio of 24:76 and
11% by weight of an emulsion ABS graft in powder form having an A:B:S weight ratio of 12:58:30 and
14% by weight of a bisphenol A-based oligophosphate which is free-flowing at 23° C., especially BDP, and
4.3% by weight of a powder mixture containing 3% by weight of a linear polycarbonate based on bisphenol A and having a relative viscosity ηᵣₑₗ=1.28 (measured in CH₂Cl₂ as solvent at 25° C. and at a concentration of 0.5 g/100 ml) and 0.1% by weight of stabilizers, 0.8% by weight of flame retardants, and 0.4% by weight of demolding agents.

In examples 20-29, the formulation is compounded with the following parameters specified in table 1: screw shaft speeds (table 1, column p), mass flow rates (table 1, column o) and the resulting specific mechanical energy inputs (table 1, column q) and temperatures of the melt exiting from the nozzle plate (table 1, column r). This results in the numbers of pellets with unmelted particles likewise given in table 1 (table 1, column w).

In examples 20-23, the pellet diameter of the low-viscosity polycarbonate formulation component was increased by comparison with examples 15-19 from 3.264 mm or 3.195 mm to 3.603 mm (see table 1, column c.2), while the higher-viscosity polycarbonate formulation component remained unchanged (see table 1, column c.1).

In examples 24-27, the pellet diameter of the higher-viscosity polycarbonate formulation component was increased by comparison with examples 15-19 from 3.143 mm or 3.122 mm to 3.547 mm (see table 1, column c.1), while the low-viscosity polycarbonate formulation component remained unchanged (see table 1, column c.2).

In examples 28-29, the pellet diameter of the SAN formulation component was increased by comparison with examples 15-19 from 3.488 mm to 4.002 mm (see table 1, column c.3), while the polycarbonate formulation components remained unchanged (see table 1, column c.1 and c.2).

Comparison of examples 20-23 with examples 15-19 shows that an increase in the pellet diameter of the low-viscosity polycarbonate formulation components has no effect on the quality of plastification. Equal process parameters of mass flow rate and screw shaft speed result in comparable qualities of plastification (see table 1, columns o, p and w).

Comparison of examples 24-27 with examples 15-19 shows that an increase in the pellet diameter of the high-viscosity polycarbonate formulation components distinctly worsens the quality of plastification with equal process parameters of mass flow rate and screw shaft speed (see table 1, columns o, p and w).

Comparison of examples 28-29 with examples 15-19 shows that an increase in the pellet diameter of the SAN formulation component has no effect on the quality of plastification. Equal process parameters of mass flow rate and screw shaft speed result in comparable qualities of plastification (see table 1, columns o, p and w).

As shown by the comparison of examples 15-29, irrespective of the pellet diameter and the speed chosen or the mass flow rate chosen, a plastic mass according to the invention is always obtained when the melting rate (table 1, column x) is at least 1.18, especially at least 1.36, whereas, in the case of a melting rate of less than 1.18, especially in the case of a melting rate of 1.16 or less, the number of pellets with unmelted particles is unacceptable.

### Examples 30-33: Variation of the Raw Materials for the Same Formulation

A ZE60B UTXi twin screw extruder from KraussMaffei Extrusion GmbH was used for the production of the plastic mass in examples 30-33. The design features of the extruder can be found in table 1 in columns k to n. The basic construction of the extruder used for examples 30-33 is shown in FIG. 4.

In examples 30-33, all components of the formulation, except for the additive that is free-flowing at 23° C., were metered by means of conventional gravimetric differential metering balances via the intake funnel 1 depicted into the main intake of the screw machine in housing 2.

In the region of the housings 2 to 7 is a conveying zone for all components of the formulation.

In the region of the housing 8 is a plastifying zone consisting of various two- and three-flight kneading blocks of various width and also toothed mixing elements.

In the housing 9, the additive which is free-flowing at 23° C. was injected into the plastic mass by means of a commercial membrane piston pump (not shown) via a valve (not shown) that was screwed into a hole 14 in housing 9.

In the region of the housings 9 to 10 is a mixing zone, the screw configuration of which consists of kneading elements, toothed mixing elements and conveying elements.

In housing part 11 is the vent 13, the screw configuration of which is connected to an extraction apparatus (not shown).

In housing 12 is the pressurization zone, and downstream thereof a nozzle plate having 29 holes.

In examples 30-33, pelletization was effected in the form of strand pelletization after water-bath cooling.

The formulation which is fed into the extruder in examples 30-33 consists of a mixture of:
63.7% by weight of pellets of a linear polycarbonate based on bisphenol A having a relative viscosity ηᵣₑₗ=1.28 (measured in CH₂Cl₂ as solvent at 25° C. and at a concentration of 0.5 g/100 ml) and
7% by weight of a styrene-acrylonitrile copolymer (SAN) having an A:S weight ratio of 24:76 and
11% by weight of an emulsion ABS graft in powder form having an A:B:S weight ratio of 12:58:30 and
14% by weight of a bisphenol A-based oligophosphate which is free-flowing at 23° C., especially BDP, and
4.3% by weight of a powder mixture containing 3% by weight of a linear polycarbonate based on bisphenol A and having a relative viscosity ηᵣₑₗ=1.28 (measured in CH₂Cl₂ as solvent at 25° C. and at a concentration of 0.5 g/100 ml) and 0.1% by weight of stabilizers, 0.8% by weight of flame retardants, and 0.4% by weight of demolding agents.

In examples 30-33, the formulation is compounded with the following parameters specified in table 1: screw shaft speeds (table 1, column p), mass flow rates (table 1, column o) and the resulting specific mechanical energy inputs (table 1, column q) and temperatures of the melt exiting from the nozzle plate (table 1, column r). This results in the numbers of pellets with unmelted particles likewise given in table 1 (table 1, column w).

Comparison of examples 30-33 with examples 15-19 shows that the use of just one polycarbonate in the formulation (examples 30-33) by comparison with the use of two polycarbonate components with different viscosity but exactly the same mixed viscosity overall (examples 15-19), with the same process parameters of mass flow rate and screw shaft speed, leads to a much better quality of plastification (see table 1, columns o, p and w).

As also shown by the comparison of examples 15-19 and 30-33, irrespective of the chosen composition of the formulation with regard to the polycarbonate component(s) and the speed chosen or the mass flow rate chosen, a plastic mass according to the invention is always obtained when the melting rate (table 1, column x) is at least 1.18, especially at least 1.19, whereas, in the case of a melting rate of less than 1.18, especially in the case of a melting rate of 1.14 or less, the number of pellets with unmelted particles is unacceptable.

### Examples 34-35: Variation of Extruder Diameter D

A ZSK92 Mc twin screw extruder from Coperion GmbH was used for the production of the plastic mass in examples 34 and 35. The design features of the extruder can be found in table 1 in columns k to n. The basic construction of the extruder used for examples 34 and 35 is shown in FIG. 5.

In examples 34 and 35, all components of the formulation were metered by means of conventional gravimetric differential metering balances via the intake funnel 15 depicted into the main intake of the screw machine in housing 16.

In the region of the housings 17 to 18 is a conveying zone for all components of the formulation.

In the region of the housings 19 to 20 is a plastifying zone, the screw configuration of which consists of various two- and three-flight kneading blocks of various width and also toothed mixing elements.

In the region of the housing 21 is a mixing zone, the screw configuration of which consists of toothed mixing elements and conveying elements.

In housing part 22 is the vent 24, which is connected to an extraction apparatus (not shown).

In housing 23 is the pressurization zone, and downstream thereof a nozzle plate having 100 holes.

Pelletization in examples 34 and 35 was effected in the form of underwater pelletization.

The formulation which is fed into the extruder in examples 34 and 35 consists of a mixture of:
60.3% by weight of pellets of a linear polycarbonate based on bisphenol A having a relative viscosity ηᵣₑₗ=1.28 (measured in CH₂Cl₂ as solvent at 25° C. and at a concentration of 0.5 g/100 ml) and
17.2% by weight of emulsion ABS pellets having an A:B:S weight ratio of 20:24:56 and
8.9% by weight of bulk ABS pellets having an A:B:S weight ratio of 25:10:65 and
9.5% by weight of a styrene-acrylonitrile copolymer (SAN) having an A:S weight ratio of 24:76 and
4.1% by weight of a powder mixture containing 3% by weight of an emulsion ABS graft in powder form with an A:B:S weight ratio of 12:58:30, and 0.35% by weight of stabilizers and 0.75% by weight of demolding agents.

In comparative example 34 and example 35 according to the invention, the formulation is compounded with the following parameters specified in table 1: screw shaft speeds (table 1, column p), mass flow rates (table 1, column o) and the resulting specific mechanical energy inputs (table 1, column q) and temperatures of the melt exiting from the nozzle plate (table 1, column r). This results in the numbers of pellets with unmelted particles likewise given in table 1 (table 1, column w).

As shown by examples 34 and 35 by comparison with examples 1-6, irrespective of the extruder diameter and the speed chosen or the mass flow rate chosen for the formulation, a plastic mass according to the invention is always obtained when the melting rate (table 1, column x) is at least 1.18, especially at least 1.53, whereas, in the case of a melting rate of less than 1.18, especially in the case of a melting rate of 0.77 or less, the number of pellets with unmelted particles is unacceptable.

### Examples 36-40: Variation of the Metering Point of an Additive that is Free-Flowing at 23° C.

A ZE60B UTXi twin screw extruder from KraussMaffei Extrusion GmbH was used for the production of the plastic mass in examples 36-40. The design features of the extruder can be found in table 1 in columns k to n. The basic construction of the extruder used for examples 36-40 is shown in FIG. 4.

In examples 36-40, all components of the formulation, except for the additive that is free-flowing at 23° C., were metered by means of conventional gravimetric differential metering balances via the intake funnel 1 depicted into the main intake of the screw machine in housing 2.

In the region of the housings 2 to 7 is a conveying zone for all components of the formulation.

In the region of the housing 8 is a plastifying zone consisting of various two- and three-flight kneading blocks of various width and also toothed mixing elements.

In the housing 9, the additive which is free-flowing at 23° C. was injected into the plastic mass by means of a commercial membrane piston pump (not shown) via a valve (not shown) that was screwed into a hole 14 in housing 9.

In the region of the housings 9 to 10 is a mixing zone consisting of kneading elements, toothed mixing elements and conveying elements.

In housing part 11 is the vent 13, which is connected to an extraction apparatus (not shown).

In housing 12 is the pressurization zone, and downstream thereof a nozzle plate having 29 holes.

In examples 36-40, pelletization was effected in the form of strand pelletization after water-bath cooling.

The formulation which is fed into the extruder in examples 36-40 consists of a mixture of:
58.7% by weight of pellets of a linear polycarbonate based on bisphenol A having a relative viscosity ηᵣₑₗ=1.28 (measured in CH₂Cl₂ as solvent at 25° C. and at a concentration of 0.5 g/100 ml) and
9.3% by weight of a styrene-acrylonitrile copolymer (SAN) having an A:S weight ratio of 24:76 and
8.7% by weight of an emulsion ABS graft in powder form having an A:B:S weight ratio of 12:58:30 and
20% by weight of a bisphenol A-based oligophosphate which is free-flowing at 23° C., especially BDP, and
4.3% by weight of a powder mixture containing 3% by weight of a linear polycarbonate based on bisphenol A and having a relative viscosity ηᵣₑₗ=1.28 (measured in CH₂Cl₂ as solvent at 25° C. and at a concentration of 0.5 g/100 ml) and 0.1% by weight of stabilizers, 0.8% by weight of flame retardants, and 0.4% by weight of demolding agents.

In examples 36-40, the formulation is compounded with the following parameters specified in table 1: screw shaft speeds (table 1, column p), mass flow rates (table 1, column o) and the resulting specific mechanical energy inputs (table 1, column q) and temperatures of the melt exiting from the nozzle plate (table 1, column r). This results in the numbers of pellets with unmelted particles likewise given in table 1 (table 1, column w).

Comparison of examples 36-40 shows that the quality of plastification, with the same process parameters of mass flow rate and screw shaft speed, increases with the lateness of addition of the additive that is free-flowing at 23° C. (see table 1, columns o, p and w).

As also shown by the comparison of examples 36-40, irrespective of the site of addition of the additive that is free-flowing at 23° C. and the speed chosen or the mass flow rate chosen, a plastic mass according to the invention is always obtained when the melting rate (table 1, column x) is at least 1.18, especially at least 1.35, whereas, in the case of a melting rate of less than 1.18, especially in the case of a melting rate of 1.11 or less, the number of pellets with unmelted particles is unacceptable.

### Examples 41-44: Variation of Number of Extruder Shafts

An extruder with twelve corotating shafts of the REI ring extruder type from CPM Extricom Extrusion GmbH was used for the production of the plastic mass in examples 41-44. The design features of the extruder can be found in table 1 in columns k to n. The basic construction of the extruder used for examples 41-44 is shown in FIG. 6.

In examples 41-44, all components of the formulation were metered by means of conventional gravimetric differential metering balances via the intake funnel 25 depicted into the main intake of the screw machine in housing 26.

In the region of the housings 27 to 29 is a conveying zone for all components of the formulation.

In the region of the housing 30 is a plastifying zone, the screw configuration of which consists of various two-flight kneading blocks of various width.

In housing part 31 is the vent 33, which is connected to an extraction apparatus (not shown).

In housing 32 is the pressurization zone, and downstream thereof a nozzle plate having 6 holes.

In examples 41-44, pelletization was effected in the form of strand pelletization after water-bath cooling.

The formulation which is fed into the extruder in examples 41-44 consists of a mixture of:
28% by weight of pellets of a linear polycarbonate based on bisphenol A having a relative viscosity ηᵣₑₗ=1.28 (measured in CH₂Cl₂ as solvent at 25° C. and at a concentration of 0.5 g/100 ml) and
15% by weight of pellets of a linear polycarbonate based on bisphenol A having a relative viscosity ηᵣₑₗ=1.20 (measured in CH₂Cl₂ as solvent at 25° C. and at a concentration of 0.5 g/100 ml) and
31% by weight of a styrene-acrylonitrile copolymer (SAN) having an A:S weight ratio of 24:76 and
22% by weight of an emulsion ABS graft in powder form having an A:B:S weight ratio of 12:58:30 and
4% by weight of a powder mixture containing 3.1% by weight of an emulsion ABS graft in powder form with an A:B:S weight ratio of 12:58:30, and 0.16% by weight of stabilizers and 0.74% by weight of demolding agents.

In comparative examples 41 and 42 and examples 43 and 44 according to the invention, the formulation is compounded with the following parameters specified in table 1: screw shaft speeds (table 1, column p), mass flow rates (table 1, column o) and the resulting temperatures of the melt exiting from the nozzle plate (table 1, column r). This results in the numbers of pellets with unmelted particles likewise given in table 1 (table 1, column w).

As shown by examples 41-44, even in the case of an extruder having twelve shafts, irrespective of the speed chosen or the mass flow rate chosen for the formulation, a plastic mass according to the invention is always obtained when the melting rate (table 1, column x) is at least 1.18, especially at least 1.53, whereas, in the case of a melting rate of less than 1.18, especially in the case of a melting rate of 1.03 or less, the number of pellets with unmelted particles is unacceptable.

In order to achieve comparability of the melting rate between the twelve-shaft and the twin-shaft screw machine, the mass flow rate m has to be divided by 6 in the calculation of the melting rate of the twelve-shaft screw machine, neglecting the fact that the twelve-shaft screw machine is not six twin-shaft screw machines, but rather that throughput-increasing effects occur because, for each screw, two adjacent screws are simultaneously intermeshing, rather than just one screw as in the case of the twin-shaft screw machine. Dividing the mass flow rate by 6 results in an equal, dimensionless throughput, and hence comparability of the two screw machines. Dimensionless throughput is defined, for example, in Kohlgrüber, Bierdel, Rust “Polymer-Aufbereitung und Kunststoff-Compoundierung” [Polymer Processing and Plastics Compounding], Hanser-Verlag, 2019, p. 36, chapter 2.3.7, as throughput index V″, where the reference diameter D used for the twelve-shaft and the twin-shaft screw machines alike is the internal housing diameter.

### Conclusion for all Examples

Examples 1 to 44 show that good plastification of a plastic mass produced from a formulation containing at least two thermoplastic components, at least one of which is a polycarbonate, is obtained irrespective of the heat capacity of the plastic mass, the pellet diameter of the most highly viscous polycarbonate component in the formulation, the internal housing diameter of the extruder, the construction of the extruder, the metering position of an additive that is free-flowing at 23° C., the composition of the formulation, the number of shafts in the extruder, and the process parameters of mass flow rate and screw shaft speed, when the melting rate is at least 1.18.

TABLE 1
(examples 1-44)

| | | | | | | | | g | | | | |
|---|---|---|---|---|---|---|---|---|---|---|---|---|
| | | c.1 | | | | | | Viscos- | h | | | |
| | | Pellet | c.2 | | | | | ity of | Average | | j | |
| | | diameter | Pellet | | | | f | plastic | specific | | Thermal | k |
| | | of | diameter | | | | Viscos- | mass at | heat | | conduc- | Internal |
| | | highest- | of | | | | ity of | melting | capacity | i | tivity | housing |
| | | viscosity | low- | c.3 | d | e | plastic | temper- | of | Solid- | of | diameter |
| a | | poly- | viscosity | Pellet | Viscos- | Viscos- | mass at | ature | plastic | state | plastic | of screw |
| Ex- | | carbonate | poly- | diameter | ity | ity | melting | (case ii | mass | density | mass | machine |
| ample | | d | carbonate | SAN | ratio | ratio | [symbol] | and iii) | cₚ | ρ_{solids} | λ | D |
| No. | b | m | m | m | δη₁ | δη₂ | Pa s | Pa s | J/kg*K | kg/m\hat{ }3 | W/mK | mm |
| 1 | comparison | 0.003271 | — | — | 1.33803 | 0.79898 | 433 | 4309 | 2443 | 1200 | 0.23 | 66.7 |
| 2 | comparison | 0.003215 | — | — | 1.22225 | 0.79465 | 256 | 3936 | 2443 | 1200 | 0.23 | 66.7 |
| 3 | according | 0.003271 | — | — | 1.33803 | 0.79720 | 342 | 4309 | 2443 | 1200 | 0.23 | 66.7 |
| | to the | | | | | | | | | | | |
| | invention | | | | | | | | | | | |
| 4 | according | 0.003271 | — | — | 1.33803 | 0.79757 | 384 | 4309 | 2443 | 1200 | 0.23 | 66.7 |
| | to the | | | | | | | | | | | |
| | invention | | | | | | | | | | | |
| 5 | according | 0.003215 | — | — | 1.22225 | 0.79498 | 253 | 3936 | 2443 | 1200 | 0.23 | 66.7 |
| | to the | | | | | | | | | | | |
| | invention | | | | | | | | | | | |
| 6 | according | 0.003182 | — | — | 1.22225 | 0.79561 | 246 | 3936 | 2443 | 1200 | 0.23 | 66.7 |
| | to the | | | | | | | | | | | |
| | invention | | | | | | | | | | | |
| 7 | comparison | 0.003185 | — | — | 1.50284 | 1.05079 | 328 | 4839 | 2424 | 1200 | 0.23 | 66.7 |
| 8 | comparison | 0.003188 | — | — | 1.50289 | 1.04654 | 354 | 4839 | 2424 | 1200 | 0.23 | 66.7 |
| 9 | according | 0.003188 | — | — | 1.58173 | 1.04519 | 407 | 5093 | 2424 | 1200 | 0.23 | 66.7 |
| | to the | | | | | | | | | | | |
| | invention | | | | | | | | | | | |
| 10 | according | 0.003188 | — | — | 1.43323 | 1.06395 | 252 | 4615 | 2424 | 1200 | 0.23 | 66.7 |
| | to the | | | | | | | | | | | |
| | invention | | | | | | | | | | | |
| 11 | comparison | 0.003132 | — | — | 2.75071 | 0.51053 | 224 | 21610 | 2203 | 1200 | 0.23 | 66.7 |
| 12 | according | 0.003132 | — | — | 2.75086 | 0.51962 | 200 | 21612 | 2203 | 1200 | 0.23 | 66.7 |
| | to the | | | | | | | | | | | |
| | invention | | | | | | | | | | | |
| 13 | according | 0.003132 | — | — | 2.75077 | 0.51751 | 205 | 21611 | 2203 | 1200 | 0.23 | 66.7 |
| | to the | | | | | | | | | | | |
| | invention | | | | | | | | | | | |
| 14 | according | 0.003132 | — | — | 2.51880 | 0.53635 | 165 | 19788 | 2203 | 1200 | 0.23 | 66.7 |
| | to the | | | | | | | | | | | |
| | invention | | | | | | | | | | | |
| 15 | comparison | 0.003143 | 0.003264 | 0.003488 | 1.61481 | 0.47843 | 364 | 19113 | 2217 | 1200 | 0.23 | 66.7 |
| 16 | comparison | 0.003143 | 0.003264 | 0.003488 | 1.32560 | 0.52629 | 270 | 15690 | 2217 | 1200 | 0.23 | 66.7 |
| 17 | comparison | 0.003143 | 0.003264 | 0.003488 | 1.32558 | 0.52140 | 276 | 15690 | 2217 | 1200 | 0.23 | 66.7 |
| 18 | according | 0.003143 | 0.003264 | 0.003488 | 1.61480 | 0.48364 | 352 | 19113 | 2217 | 1200 | 0.23 | 66.7 |
| | to the | | | | | | | | | | | |
| | invention | | | | | | | | | | | |
| 19 | according | 0.003122 | 0.003195 | 0.003488 | 1.32560 | 0.54916 | 241 | 15690 | 2217 | 1200 | 0.23 | 66.7 |
| | to the | | | | | | | | | | | |
| | invention | | | | | | | | | | | |
| 20 | comparison | 0.003122 | 0.003603 | 0.003408 | 1.61487 | 0.48016 | 360 | 19114 | 2217 | 1200 | 0.23 | 66.7 |
| 21 | comparison | 0.003122 | 0.003603 | 0.003408 | 1.32562 | 0.52186 | 276 | 15690 | 2217 | 1200 | 0.23 | 66.7 |

(examples 1-44) continued

| | | | | | | | | g | | | | |
|---|---|---|---|---|---|---|---|---|---|---|---|---|
| | | c.1 | | | | | | Viscos- | h | | | |
| | | Pellet | c.2 | | | | | ity of | Average | | j | |
| | | diameter | Pellet | | | | f | plastic | specific | | Thermal | k |
| | | of | diameter | | | | Viscos- | mass at | heat | | conduc- | Internal |
| | | highest- | of | | | | ity of | melting | capacity | i | tivity | housing |
| | | viscosity | low- | c.3 | d | e | plastic | temper- | of | Solid- | of | diameter |
| a | | poly- | viscosity | Pellet | Viscos- | Viscos- | mass at | ature | plastic | state | plastic | of screw |
| Ex- | | carbonate | poly- | diameter | ity | ity | melting | (case ii | mass | density | mass | machine |
| ample | | d | carbonate | SAN | ratio | ratio | [symbol] | and iii) | cₚ | ρ_{solids} | λ | D |
| No. | b | m | m | m | δη₁ | δη₂ | Pa s | Pa s | J/kg*K | kg/m\hat{ }3 | W/mK | mm |
| 22 | according | 0.003122 | 0.003603 | 0.003408 | 1.32561 | 0.55736 | 233 | 15690 | 2217 | 1200 | 0.23 | 66.7 |
| | to the | | | | | | | | | | | |
| | invention | | | | | | | | | | | |
| 23 | according | 0.003122 | 0.003603 | 0.003408 | 1.61480 | 0.48791 | 343 | 19113 | 2217 | 1200 | 0.23 | 66.7 |
| | to the | | | | | | | | | | | |
| | invention | | | | | | | | | | | |
| 24 | comparison | 0.003547 | 0.003195 | 0.003408 | 1.61477 | 0.47509 | 372 | 19113 | 2217 | 1200 | 0.23 | 66.7 |
| 25 | comparison | 0.003547 | 0.003195 | 0.003408 | 1.61481 | 0.48225 | 355 | 19113 | 2217 | 1200 | 0.23 | 66.7 |
| 26 | comparison | 0.003547 | 0.003195 | 0.003408 | 1.32561 | 0.54831 | 242 | 15690 | 2217 | 1200 | 0.23 | 66.7 |
| 27 | comparison | 0.003547 | 0.003195 | 0.003408 | 1.32563 | 0.52058 | 278 | 15691 | 2217 | 1200 | 0.23 | 66.7 |
| 28 | comparison | 0.003239 | 0.003240 | 0.004002 | 1.61471 | 0.46119 | 412 | 19112 | 2217 | 1200 | 0.23 | 66.7 |
| 29 | comparison | 0.003239 | 0.003240 | 0.004002 | 1.61471 | 0.45333 | 439 | 19112 | 2217 | 1200 | 0.23 | 66.7 |
| 30 | according | 0.003153 | — | — | 1.32562 | 0.74340 | 255 | 15690 | 2217 | 1200 | 0.23 | 66.7 |
| | to the | | | | | | | | | | | |
| | invention | | | | | | | | | | | |
| 31 | comparison | 0.003153 | — | — | 1.32557 | 0.74376 | 254 | 15690 | 2217 | 1200 | 0.23 | 66.7 |
| 32 | according | 0.003153 | — | — | 1.61486 | 0.68606 | 336 | 19114 | 2217 | 1200 | 0.23 | 66.7 |
| | to the | | | | | | | | | | | |
| | invention | | | | | | | | | | | |
| 33 | according | 0.003153 | — | — | 1.32563 | 0.77535 | 225 | 15690 | 2217 | 1200 | 0.23 | 66.7 |
| | to the | | | | | | | | | | | |
| | invention | | | | | | | | | | | |
| 34 | comparison | 0.003391 | — | — | 1.30353 | 0.79717 | 447 | 4198 | 2443 | 1200 | 0.23 | 92.8 |
| 35 | according | 0.003391 | — | — | 1.36460 | 0.79880 | 311 | 4394 | 2443 | 1200 | 0.23 | 92.8 |
| | to the | | | | | | | | | | | |
| | invention | | | | | | | | | | | |
| 36 | comparison | 0.003236 | — | — | 1.36871 | 0.28901 | 521 | 32804 | 2217 | 1200 | 0.23 | 66.7 |
| 37 | according | 0.003236 | — | — | 1.28944 | 0.31718 | 320 | 30904 | 2217 | 1200 | 0.23 | 66.7 |
| | to the | | | | | | | | | | | |
| | invention | | | | | | | | | | | |
| 38 | comparison | 0.003236 | — | — | 1.28944 | 0.29789 | 411 | 30904 | 2217 | 1200 | 0.23 | 66.7 |
| 39 | comparison | 0.003236 | — | — | 1.28944 | 0.30988 | 347 | 30904 | 2217 | 1200 | 0.23 | 66.7 |
| 40 | according | 0.003236 | — | — | 1.02039 | 0.35487 | 228 | 24456 | 2217 | 1200 | 0.23 | 66.7 |
| | to the | | | | | | | | | | | |
| | invention | | | | | | | | | | | |
| 41 | comparison | 0.003236 | — | — | 1.17229 | 0.91894 | 450 | 3775 | 2868 | 1200 | 0.20 | 19 |
| 42 | comparison | 0.003236 | — | — | 1.28608 | 0.93006 | 761 | 4141 | 2868 | 1200 | 0.20 | 19 |
| 43 | according | 0.003236 | — | — | 1.43215 | 0.98359 | 1182 | 4612 | 2868 | 1200 | 0.20 | 19 |
| | to the | | | | | | | | | | | |
| | invention | | | | | | | | | | | |
| 44 | according | 0.003236 | — | — | 1.28608 | 0.92729 | 595 | 4141 | 2868 | 1200 | 0.20 | 19 |
| | to the | | | | | | | | | | | |
| | invention | | | | | | | | | | | |

(examples 1-44) continued

| | | l | | | | | |
|---|---|---|---|---|---|---|---|
| | | Ratio of | m | n | | | |
| | | length to | Longitudinal | Longitudinal | o | p | q |
| | | internal | section | section | Mass | Speed | Specific |
| a | | housing | of screw | of screw | flow | of screw | mechanical |
| Ex- | | diameter | machine for | machine for | rate | shafts | energy |
| ample | | of screw | τ₁ | τ₂ | \dot{m} | n | input |
| No. | b | machine | mm | mm | kg/h | min⁻¹ | kWh/kg |
| 1 | comparison | 41.4 | 1463 | — | 1050 | 400 | 0.139 |
| 2 | comparison | 41.4 | 1463 | — | 1150 | 600 | 0.150 |
| 3 | according | 41.4 | 1463 | — | 700 | 400 | 0.145 |
| | to the | | | | | | |
| | invention | | | | | | |
| 4 | according | 41.4 | 1463 | — | 950 | 400 | 0.139 |
| | to the | | | | | | |
| | invention | | | | | | |
| 5 | according | 41.4 | 1463 | — | 1050 | 600 | 0.157 |
| | to the | | | | | | |
| | invention | | | | | | |
| 6 | according | 41.4 | 1463 | — | 1000 | 600 | 0.159 |
| | to the | | | | | | |
| | invention | | | | | | |
| 7 | comparison | 41.4 | 1463 | — | 1350 | 500 | 0.144 |
| 8 | comparison | 41.4 | 1463 | — | 1400 | 500 | 0.142 |
| 9 | according | 41.4 | 1463 | — | 1030 | 400 | 0.140 |
| | to the | | | | | | |
| | invention | | | | | | |
| 10 | according | 41.4 | 1463 | — | 1200 | 600 | 0.156 |
| | to the | | | | | | |
| | invention | | | | | | |
| 11 | comparison | 41.4 | 514 | 949 | 1100 | 400 | 0.127 |
| 12 | according | 41.4 | 514 | 949 | 900 | 400 | 0.134 |
| | to the | | | | | | |
| | invention | | | | | | |
| 13 | according | 41.4 | 514 | 949 | 1000 | 400 | 0.131 |
| | to the | | | | | | |
| | invention | | | | | | |
| 14 | according | 41.4 | 514 | 949 | 1100 | 500 | 0.136 |
| | to the | | | | | | |
| | invention | | | | | | |
| 15 | comparison | 41.4 | 514 | 949 | 850 | 400 | 0.118 |
| 16 | comparison | 41.4 | 514 | 949 | 1000 | 600 | 0.129 |
| 17 | comparison | 41.4 | 514 | 949 | 1100 | 600 | 0.128 |
| 18 | according | 41.4 | 514 | 949 | 750 | 400 | 0.121 |
| | to the | | | | | | |
| | invention | | | | | | |
| 19 | according | 41.4 | 514 | 949 | 850 | 600 | 0.134 |
| | to the | | | | | | |
| | invention | | | | | | |
| 20 | comparison | 41.4 | 514 | 949 | 850 | 400 | 0.117 |
| 21 | comparison | 41.4 | 514 | 949 | 1100 | 600 | 0.127 |

(examples 1-44) continued

| | | | | | | w | |
|---|---|---|---|---|---|---|---|
| | | | | | | Number | |
| | | | | | | of pellets | |
| | | s | | | v | with | |
| | r | Melting | | | Pressure | unmelted | |
| a | Melting | temperature, | | | upstream | particles | |
| Ex- | temperature, | case ii | t | u | of nozzle | in 330 | x |
| ample | case i | and iii | τ₁ | τ₂ | plate | pellets | Melting |
| No. | ° C. | ° C. | s | s | bar | % | rate |
| 1 | 285 | 230 | 13.5610 | 0.0000 | 42 | 6.82 | 1.08 |
| 2 | 301 | 230 | 10.3660 | 0.0000 | 35 | 5.4 | 1.07 |
| 3 | 292 | 230 | 16.1170 | 0.0000 | 30 | 0 | 1.93 |
| 4 | 289 | 230 | 13.9870 | 0.0000 | 36 | 0.57 | 1.23 |
| 5 | 301 | 230 | 10.9340 | 0.0000 | 35 | 0.9 | 1.24 |
| 6 | 302 | 230 | 11.2180 | 0.0000 | 34 | 0.0 | 1.36 |
| 7 | 300 | 230 | 10.5790 | 0.0000 | 41 | 2.65 | 0.98 |
| 8 | 299 | 230 | 10.4370 | 0.0000 | 42 | 6.32 | 0.93 |
| 9 | 295 | 230 | 13.2060 | 0.0000 | 40 | 0 | 1.35 |
| 10 | 311 | 230 | 10.0820 | 0.0000 | 34 | 0.25 | 1.20 |
| 11 | 291 | 184 | 4.1180 | 9.5140 | 65 | 6.84 | 1.12 |
| 12 | 295 | 184 | 4.8280 | 10.0820 | 54 | 0 | 1.56 |
| 13 | 294 | 184 | 4.5440 | 9.6560 | 59 | 0.7 | 1.33 |
| 14 | 302 | 184 | 4.1180 | 7.9520 | 53 | 1.07 | 1.26 |
| 15 | 275 | 166 | 5.1120 | 9.7980 | 46 | 10.54 | 1.14 |
| 16 | 287 | 166 | 4.1180 | 6.9580 | 39 | 5.56 | 1.02 |
| 17 | 286 | 166 | 3.8340 | 6.8160 | 42 | 17 | 0.88 |
| 18 | 276 | 166 | 5.6800 | 10.0820 | 41 | 0.91 | 1.40 |
| 19 | 291 | 166 | 4.6860 | 7.2420 | 31 | 0 | 1.36 |
| 20 | 276 | 166 | 5.1120 | 9.7980 | 45 | 8.45 | 1.16 |
| 21 | 286 | 166 | 3.8340 | 6.8160 | 42 | 15.48 | 0.89 |

(examples 1-44) continued

| | | l | m | n | | | |
|---|---|---|---|---|---|---|---|
| | | Ratio of | Longi- | Longi- | | | |
| | | length to | tudinal | tudinal | o | p | q |
| | | internal | section | section | Mass | Speed | Specific |
| a | | housing | of screw | of screw | flow | of screw | mechanical |
| Ex- | | diameter | machine | machine | rate | shafts | energy |
| ample | | of screw | for τ₁ | for τ₂ | \dot{m} | n | input |
| No. | b | machine | mm | mm | kg/h | min⁻¹ | kWh/kg |
| 22 | according | 41.4 | 514 | 949 | 850 | 600 | 0.134 |
| | to the | | | | | | |
| | invention | | | | | | |
| 23 | according | 41.4 | 514 | 949 | 750 | 400 | 0.122 |
| | to the | | | | | | |
| | invention | | | | | | |
| 24 | comparison | 41.4 | 514 | 949 | 850 | 400 | 0.117 |
| 25 | comparison | 41.4 | 514 | 949 | 750 | 400 | 0.122 |
| 26 | comparison | 41.4 | 514 | 949 | 850 | 600 | 0.135 |
| 27 | comparison | 41.4 | 514 | 949 | 1100 | 600 | 0.126 |
| 28 | comparison | 41.4 | 514 | 949 | 850 | 400 | 0.119 |
| 29 | comparison | 41.4 | 514 | 949 | 950 | 400 | 0.115 |
| 30 | according | 41.4 | 514 | 949 | 1000 | 600 | 0.130 |
| | to the | | | | | | |
| | invention | | | | | | |
| 31 | comparison | 41.4 | 514 | 949 | 1100 | 600 | 0.133 |
| 32 | according | 41.4 | 514 | 949 | 750 | 400 | 0.124 |
| | to the | | | | | | |
| | invention | | | | | | |
| 33 | according | 41.4 | 514 | 949 | 850 | 600 | 0.140 |
| | to the | | | | | | |
| | invention | | | | | | |
| 34 | comparison | 31 | 1790 | — | 3000 | 455 | 0.147 |
| 35 | according | 31 | 1790 | — | 2200 | 360 | 0.156 |
| | to the | | | | | | |
| | invention | | | | | | |
| 36 | comparison | 41.4 | 514 | 949 | 500 | 360 | 0.061 |
| 37 | according | 41.4 | 514 | 949 | 500 | 400 | 0.122 |
| | to the | | | | | | |
| | invention | | | | | | |
| 38 | comparison | 41.4 | 514 | 949 | 700 | 400 | 0.109 |
| 39 | comparison | 41.4 | 514 | 949 | 700 | 400 | 0.114 |
| 40 | according | 41.4 | 514 | 949 | 700 | 600 | 0.135 |
| | to the | | | | | | |
| | invention | | | | | | |
| 41 | comparison | 34 | 361 | — | 100 | 800 | 0.013 |
| 42 | comparison | 34 | 361 | — | 120 | 600 | 0.011 |
| 43 | according | 34 | 361 | — | 70 | 400 | 0.013 |
| | to the | | | | | | |
| | invention | | | | | | |
| 44 | according | 34 | 361 | — | 51 | 600 | 0.015 |
| | to the | | | | | | |
| | invention | | | | | | |

(examples 1-44) continued

| | | | | | | w | |
|---|---|---|---|---|---|---|---|
| | | | | | | Number | |
| | | | | | | of pellets | |
| | | s | | | v | with | |
| | r | Melting | | | Pressure | unmelted | |
| a | Melting | temperature, | | | upstream | particles | |
| Ex- | temperature, | case ii | t | u | of nozzle | in 330 | x |
| ample | case i | and iii | τ₁ | τ₂ | plate | pellets | Melting |
| No. | ° C. | ° C. | s | s | bar | % | rate |
| 22 | 293 | 166 | 4.6860 | 7.2420 | 31 | 0.39 | 1.37 |
| 23 | 277 | 166 | 5.6800 | 10.0820 | 39 | 1.29 | 1.42 |
| 24 | 274 | 166 | 5.1120 | 9.7980 | 45 | 31.22 | 0.89 |
| 25 | 276 | 166 | 5.6800 | 10.0820 | 39 | 7.78 | 1.10 |
| 26 | 291 | 166 | 4.6860 | 7.2420 | 31 | 6.47 | 1.06 |
| 27 | 285 | 166 | 3.8340 | 6.8160 | 41 | 70.96 | 0.69 |
| 28 | 271 | 166 | 5.1120 | 9.3720 | 38.2 | 8.79 | 1.04 |
| 29 | 268 | 166 | 4.6860 | 9.2300 | 44.5 | 23.95 | 0.87 |
| 30 | 289 | 166 | 4.1180 | 6.9580 | 38 | 1.5 | 1.19 |
| 31 | 289 | 166 | 3.8340 | 6.8160 | 42 | 3.95 | 1.03 |
| 32 | 278 | 166 | 5.6800 | 10.0820 | 39 | 0.59 | 1.59 |
| 33 | 294 | 166 | 4.6860 | 7.2420 | 32 | 0 | 1.55 |
| 34 | 284 | 230 | 9.8690 | 0.0000 | | 39.50 | 0.77 |
| 35 | 295 | 230 | 17.4518 | 0.0000 | | 0 | 1.53 |
| 36 | 250 | 144 | 0.0000 | 22.4360 | 38 | 100 | 0.82 |
| 37 | 267 | 144 | 3.5500 | 17.6080 | 24 | 0 | 1.43 |
| 38 | 258 | 144 | 3.8340 | 12.9220 | 39 | 91 | 0.89 |
| 39 | 264 | 144 | 5.9640 | 10.7920 | 34 | 11.5 | 1.11 |
| 40 | 280 | 144 | 5.5380 | 9.2300 | 23 | 0.3 | 1.35 |
| 41 | 288 | 230 | 6.6740 | 0.0000 | 31 | 7.2 | 1.03 |
| 42 | 273 | 230 | 7.1000 | 0.0000 | 36 | 10 | 0.75 |
| 43 | 262 | 230 | 11.3600 | 0.0000 | 33 | 0 | 1.53 |
| 44 | 280 | 230 | 11.3600 | 0.0000 | 23 | 0 | 2.83 |

[symbol]

indicates data missing or illegible when filed

1. A process comprising producing a plastic mass in a multishaft screw machine with corotating parallel screw shafts that rotate at equal speed,
wherein the screw shafts rotate at a speed n,
wherein the plastic mass is produced from a formulation containing at least two thermoplastic components,
wherein at least one of the at least two thermoplastic components is a polycarbonate,
wherein the plastic mass
(i) does not include any additive that is free-flowing at 23° C., or
(ii) includes exactly one additive that is free-flowing at 23° C., or
(iii) includes at least two additives that are free-flowing at 23° C.,
wherein dynamic viscosity measured to ISO 11443:2014 Method A2 of the plastic mass at a shear rate \dot{γ} of 200 l/s
and
in case (i)
of a temperature of 230° C.
and
in case (ii)
of a temperature of 230° C. minus 230° C. multiplied by twice the proportion by mass of the exactly one additive that is free-flowing at 23° C. based on the mass of the plastic mass,
and
in case (iii)
of a temperature of 230° C. minus 230° C. multiplied by twice the sum total of the proportions by mass of the at least two additives that are free-flowing at 23° C. based on the mass of the plastic mass,
based on the viscosity measured to ISO 11443:2014 Method A2 of at least one of these thermoplastic components, measured at a shear rate Y of 200 l/s and a temperature of 230° C., is in a ratio of 0.3 to 3,
and wherein the at least two thermoplastic components differ in at least one of the following features:
at least one structural unit is different,
or
the difference in relative solution viscosity, measured to EN ISO 1628-1:2021, is at least 5%,
wherein the process is characterized by a melting rate,
wherein the melting rate in the longitudinal section of the screw machine that begins at a distance of twice the internal housing diameter D upstream of the first screw element that is not a conveying element and ends with the last screw element of the screw machine is from 1.18 to 8, where, for this melting rate:
$$Melting rate = \frac{( {τ}_{1} \cdot {δη}_{1} + {τ}_{2} \cdot {δη}_{2} ) \cdot λ \cdot n \cdot {D}^{3}}{{d}^{2} \cdot {c}_{p} \cdot \dot{m}}$$
and where:
τ₁ is the average dwell time of the plastic mass in the longitudinal section of the screw machine that begins at a distance of twice the internal housing diameter D upstream of the first screw element that is not a conveying element,
and
in case (i)
ends with the last screw element of the screw machine,
and in cases (ii) or (iii)
ends with the first addition site for an additive that is free-flowing at 23° C. downstream of the first screw element that is not a conveying element,
and where
ση₁ is the ratio of the dynamic viscosity of the plastic mass at a shear rate \dot{γ} corresponding to the speed n of the screw shafts and
in case (i)
of a temperature of 230° C.
and
in case (ii)
of a temperature of 230° C. minus 230° C. multiplied by twice the proportion by mass of the exactly one additive that is free-flowing at 23° C. based on the mass of the plastic mass,
and
in case (iii)
of a temperature of 230° C. minus (230° C. multiplied by twice the sum total of the proportions by mass of the at least two additives that are free-flowing at 23° C. based on the total mass of the plastic mass)
based on the dynamic viscosity of the thermoplastic component having the highest dynamic viscosity measured at a shear rate \dot{γ} of 200 l/s and
in case (i)
of a temperature of 230° C.
and
in case (ii)
of a temperature of 230° C. minus 230° C. multiplied by twice the proportion by mass of the exactly one additive that is free-flowing at 23° C. based on the mass of the plastic mass,
and
in case (iii)
of a temperature of 230° C. minus (230° C. multiplied by twice the sum total of the proportions by mass of the at least two additives that are free-flowing at 23° C. based on the mass of the plastic mass),
τ₂ is
in case (ii) and in case (iii)
the average dwell time of the plastic mass in the longitudinal section of the screw machine that begins with the first addition site for an additive that is free-flowing at 23° C. downstream at a distance of twice the internal housing diameter D upstream of the first screw element that is not a conveying element and ends with the last screw element of the screw machine,
and
in case (i)
is zero,
δη₂ is the ratio of the dynamic viscosity of the plastic mass at a shear rate \dot{γ} corresponding to the speed n of the screw shafts and at a temperature corresponding to the temperature of the plastic mass at the end of the last screw element, based on the dynamic viscosity of the thermoplastic component having the highest dynamic viscosity measured at a shear rate of 200 l/s and at a temperature corresponding to the temperature of the plastic mass at the end of the last screw element,
λ is the thermal conductivity measured to EN ISO 11357-8:2021 at 23° C., exhibited by the plastic mass immediately after exiting from the screw machine,
n is the speed of the screw shafts of the screw machine,
d is the diameter of the pellets of the polycarbonate present in the formulation for production of the plastic mass that has the highest relative viscosity measured to EN ISO 1628-1:2021,
D is the internal diameter of the housings of the screw machine, where the internal housing diameter D is the same for all housings of the screw machine,
cₚ is the average specific heat capacity measured to ISO 11357-4:2021 in the temperature range between 250° C. and 300° C.,
\dot{m} is the mass flow rate [kg/s] of the plastic mass in the screw machine.

2. The process as claimed in claim 1, wherein the melting rate is in a range of 1.18 to 5.

3. The process as claimed in claim 1, wherein the melting rate is in a range of 1.2 to 3.

4. The process as claimed in claim 1, wherein the plastic mass comprises at least one additive that is free-flowing at 23° C., the at least one additive comprising bisphenol A bis(diphenylphosphate).

5. The process as claimed in claim 1, wherein all thermoplastic components in the formulation are polycarbonates.

6. The process as claimed in claim 1, wherein the at least two thermoplastic components comprises a thermoplastic component that is not a polycarbonate, wherein said thermoplastic component that is not a polycarbonate is selected from the group comprising the following members:
polyester carbonate, polyamide, polyesters, polylactides, polyethers, thermoplastic polyurethane, polyacetal, fluoropolymer, polyether sulfones, polyolefin, polyimide, polyacrylate, polyphenylene oxide, polyphenylene sulfide, polyether ketone, polyaryl ether ketone, styrene polymers, styrene copolymers, acrylonitrile-butadiene-styrene block copolymers and polyvinylchloride.

7. The process as claimed in claim 1, wherein the proportion of polycarbonate in the formulation for production of the plastic mass is from 20% to 98% by weight based on the weight of the formulation.

8. The process as claimed in claim 1, wherein at least one of the thermoplastic components that is a polycarbonate is an aromatic polycarbonate based on bisphenol A.

9. The process as claimed in claim 6, wherein said thermoplastic component that is not a polycarbonate is a rubber-modified vinyl (co) polymer.

10. The process as claimed in claim 6, wherein said thermoplastic component that is not a polycarbonate is polybutylene terephthalate or polyethylene terephthalate.

11. The process as claimed in claim 6, wherein said thermoplastic component that is not a polycarbonate is polyvinylidene fluoride.

12. The process as claimed in claim 6, wherein said thermoplastic component that is not a polycarbonate is polyethylene or polypropylene.

13. The process as claimed in claim 6, wherein said thermoplastic component that is not a polycarbonate is poly(methyl) methacrylate.

14. The process as claimed in claim 6, wherein said thermoplastic component that is not a polycarbonate is polystyrene.

15. The process as claimed in claim 6, wherein said thermoplastic component that is not a polycarbonate is styrene-acrylonitrile copolymer.

16. The process as claimed in claim 7, wherein the proportion of polycarbonate in the formulation for production of the plastic mass is from 40% to 80% by weight based on the weight of the formulation.

17. The process as claimed in claim 8, wherein at least one of the thermoplastic components that is a polycarbonate is a linear aromatic polycarbonate based on bisphenol A.
